(19) United States
(12) Patent Application Publication
(10) Pub. No.: US 2026/0260575 A1
(43) Pub. Date: Sep. 3, 2026

(54) SYSTEMS AND METHODS FOR LARGE LANGUAGE MODEL-BASED CONTEXT-AWARE TUTORIAL VALIDATION

(71) Applicant: Palantir Technologies Inc., Denver, CO (US)

(72) Inventors: Marie Kindblom, Paris (FR); Thomas Henri Labadie, Paris (FR); Emily Su, San Jose, CA (US)

(21) Appl. No.: 19/211,856

(22) Filed: May 19, 2025

Related U.S. Application Data
(60) Provisional application No. 63/765,386, filed on Feb. 28, 2025.

(51) Int. Cl. G09B 7/04

(52) U.S. Cl. CPC G09B 7/04

(57) ABSTRACT

Systems and methods for context-aware tutorial generation and validation using large language models (LLMs). The context-aware tutorial may be generated using an LLM, with the LLM outputting individual steps associated completion of the tutorial. The individual steps reference validation information reflecting application states that are associated with completion of the tutorial. During use of the tutorial, application states are received over a communication channel. The application states are analyzed to determine whether an end-user has completed individual steps that form the tutorial. The tutorial may be completed based on monitoring actual end-user progression through the steps.

### CROSS-REFERENCE TO RELATED APPLICATIONS

This application claims benefit of U.S. Provisional Patent Application No. 63/765386, filed February 28, 2025, and titled “SYSTEMS AND METHODS FOR CONTEXT-AWARE TUTORIAL GENERATION AND VALIDATION USING LARGE LANGUAGE MODELS (LLMS).” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques for data integration, analysis, and visualization. More specifically, the present disclosure relates to context-aware tutorial generation implementation with natural language processing.

### BACKGROUND

Tutorials provide helpful instruction regarding complex modern-day software applications. A tutorial may help, for example, to onboard users. Typically, a tutorial includes a set of instructions for a user to follow. For example, to perform a specific action using an application, a tutorial may walk through the user through a sequence of steps that result in performance of the specific action.

Large language models (LLMs) are increasingly being leveraged by developers to create, and refine, code. LLMs are machine learning models designed for natural language processing tasks and may be inferenced based on input of user questions related to specific code or coding tasks.

### SUMMARY

Embodiments of the present disclosure relate to methods, systems, and computer storage media. An example method includes causing presentation, via a first web application executing in a browser, of a chat window, the first web application being in communication with a large language model (LLM); obtaining information specifying a goal associated with a workflow through one or more second web applications configured for execution in the browser, the goal being associated with a tutorial generated, in part, using the LLM; forming a first prompt based on the specified goal and associated documentation, wherein the first web application provides the prompt to the LLM, and wherein the chat window is updated to present: information specifying steps towards the goal, wherein individual steps reference one or more second web applications; and validating information received from the LLM which is associated with the tutorial, wherein the information includes for an individual step: information identifying a particular web application associated with the step, and validation information indicative of a state associated with the particular web application that reflects successful completion of the step, wherein during use of the tutorial, the first web application is configured to receive, via a communication channel, information from the particular web application.

Embodiments of the present disclosure relate to methods, systems, and computer storage media. Another example method includes causing presentation, via a first web application executing in a browser, of a chat window, the first web application being in communication with a large language model (LLM), and the chat window reflecting one or more steps included in a tutorial; establishing communications, via a communication channel, between the first web application and a particular web application of one or more second web applications configured for execution via the browser to complete the tutorial; and monitoring, based on the communication channel, progression through the tutorial, wherein the chat window is updated based on the monitored progression, wherein each step is associated with information that indicates: a respective web application of the second web applications which is associated with the step, and validation information indicative of a state associated with the respective web application that reflects successful completion of the step, wherein monitoring progression through the tutorial includes validating completion of the steps, and wherein validating completion of a first step that indicates the particular web application comprises: validating that the particular web application is being executed, and validating that a current state of the particular web application corresponds to the validation information indicated in the information for the first step.

Accordingly, in various embodiments, large amounts of data are automatically and dynamically calculated interactively in response to user inputs, and the calculated data is efficiently and compactly presented to a user by the system. Thus, in some embodiments, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces “that are useable and easily learned by humans is a non-trivial problem for software developers.” (Dillon, A. (2003) User Interface Design. MacMillan Encyclopedia of Cognitive Science, Vol. 4, London: MacMillan, 453-458.) The various embodiments of interactive and dynamic user interfaces of the present disclosure are the result of significant research, development, improvement, iteration, and testing. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interfaces described herein may provide an optimized display of time-varying report-related information and may enable a user to more quickly access, navigate, assess, and digest such information than previous systems.

In some embodiments, data may be presented in graphical representations, such as visual representations, such as charts and graphs, where appropriate, to allow the user to comfortably review the large amount of data and to take advantage of humans’ particularly strong pattern recognition abilities related to visual stimuli. In some embodiments, the system may present aggregate quantities, such as totals, counts, and averages. The system may also utilize the information to interpolate or extrapolate, e.g. forecast, future developments.

Further, the interactive and dynamic user interfaces described herein are enabled by innovations in efficient interactions between the user interfaces and underlying systems and components. For example, disclosed herein are improved methods of receiving user inputs, translation and delivery of those inputs to various system components, automatic and dynamic execution of complex processes in response to the input delivery, automatic interaction among various components and processes of the system, and automatic and dynamic updating of the user interfaces. The interactions and presentation of data via the interactive user interfaces described herein may accordingly provide cognitive and ergonomic efficiencies and advantages over previous systems.

Various embodiments of the present disclosure provide improvements to various technologies and technological fields. For example, as described above, existing data storage and processing technology (including, e.g., in memory databases) is limited in various ways (e.g., manual data review is slow, costly, and less detailed; data is too voluminous; etc.), and various embodiments of the disclosure provide significant improvements over such technology. Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, and presentation of the updates to displayed images via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

Additional embodiments of the disclosure are described below in reference to the appended claims, which may serve as an additional summary of the disclosure.

In various embodiments, systems and/or computer systems are disclosed that comprise a computer readable storage medium having program instructions embodied therewith, and one or more processors configured to execute the program instructions to cause the one or more processors to perform operations comprising one or more aspects of the above- and/or below-described embodiments (including one or more aspects of the appended claims).

In various embodiments, computer-implemented methods are disclosed in which, by one or more processors executing program instructions, one or more aspects of the above- and/or below-described embodiments (including one or more aspects of the appended claims) are implemented and/or performed.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above- and/or below-described embodiments (including one or more aspects of the appended claims).

### BRIEF DESCRIPTION OF THE DRAWINGS

FIG. 1A is a block diagram of an example user device executing an assistant application and web application(s) in communication with a back-end system and large language model (LLM) for context-aware tutorials.

FIG. 1B is a block diagram illustrating a data management system for use with a back-end system, according to some embodiments of the present disclosure.

FIG. 2 illustrates one embodiment of a database system using an ontology.

FIG. 3A is a block diagram illustrating detail of the assistant application presenting summary information associated with an example tutorial.

FIG. 3B is a block diagram illustrating detail of the assistant application presenting steps associated with the example tutorial.

FIG. 3C is a block diagram illustrating the LLM iteratively generating the example tutorial.

FIG. 4 is a flowchart of an example process for generating, and validating, an example tutorial.

FIG. 5A is a block diagram illustrating detail of the example user device monitoring progression through an example tutorial.

FIG. 5B is a block diagram illustrating detail of the back-end system and LLM monitoring progression through the example tutorial.

FIG. 5C is a block diagram illustrating detail of the assistant application receiving a user prompt, such as a question, related to the example tutorial.

FIG. 5D is an example user interface highlighting an interactive element in an application associated with a tutorial based on the user prompt.

FIG. 6 is a flowchart of an example process for monitoring progression through an example tutorial.

FIG. 7 illustrates a computer system with which certain methods discussed herein may be implemented.

### DETAILED DESCRIPTION

### Overview

The present application describes a context-aware tutorial in which a user can traverse through a sequence of steps to perform a goal with respect to an application. The sequence of steps may be identified in an assistant application which may represent, in some embodiments, a front-end associated with a large language model (LLM). The application may represent an arbitrary application, such as an integrated development environment (IDE), tool to transform or adjust data, a tool to generate front-ends of a user interface, and so on. In some embodiments, the assistant application and application may reflect web applications which are accessed using a web browser. For example, the assistant application and application may have respective front-ends presented via the web browser while back-end system(s) may implement back-end functionality.

As will be described, the context-aware tutorial may monitor a state of the application. The state may indicate, for example, actions (e.g., user actions) performed in the application. As an example with respect to an IDE, the user may have selected a particular repository to view. The user may have also typed one or more lines of code and then triggered a build or compilation. For this example, step(s) of the tutorial may indicate that the user is to open the IDE application, select a repository or specific type of repository, and trigger a build. In this example, the IDE may output, or otherwise provide, the state(s) such that the user’s progression through the tutorial may be determined.

The state may be interpreted broadly in this application. For example, an individual application may include functionality to output its state with the state being arbitrarily defined. As an example, code which forms the individual application may reference a primitive or function that outputs a custom defined state associated with the individual application. For example, an application associated with generation of an ontology may include a state reflecting, a currently viewed screen or user interface of the application (e.g., a designer user interface), a currently selected object type, parameters or other information associated with the currently selected object type, and so on. The application may additionally output descriptive information reflecting user interactions with the application, execution of the application, and so on. In this way, the application itself can output information sufficient to determine whether a step has been met or satisfied (referred to herein as validation information).

Advantageously, the assistant application may determine completion of individual steps included in a tutorial. As one example, the assistant application may analyze the states from application(s) being used to complete the tutorial. For example, the state from an application may indicate a particular set of information and the assistant application may determine whether the particular set of information satisfies an individual step. In some embodiments, the assistant application may leverage use of an LLM to determine whether the state satisfies the individual step. Thus, in some embodiments the LLM may be leveraged to ascertain whether a user’s use, or operation, of an application satisfies the individual step. The LLM may receive (e.g., in a context window) validation information describing ways the user can complete the individual step (e.g., documentation associated with the application). In this way, the LLM may determine whether the user has completed the individual step based on its learned reasoning.

In some embodiments, the assistant application may compare the received state to stored validation information associated with the individual step. For example, a step may be defined in a tutorial as requiring receipt of a particular state from a particular application. While the tutorial is being run by a user, the assistant application may indicate completion of the step based on receipt of the particular state from the particular application. Thus, in some embodiments progression through the tutorial may be monitored based on comparisons between (1) validation information specified in steps of the tutorial and (2) states received from application(s) being used by a user.

The assistant application and application(s) may represent web applications executing on a browser. Thus, the browser may present corresponding front-ends of the web applications. The browser, as an example, may additionally execute these web applications as respective processes. In some embodiments, a communication channel may be established between the front-ends (e.g., client-side processes). In this way, the assistant application may receive contextual-information from the web application(s) via the communication channel.

With respect to communications between the front-end web applications, in some embodiments the assistant application may receive communication information (e.g., messages) from the application(s) (e.g., as a push). For example, the assistant application may subscribe to messages from the application(s). An example message may identify a current state associated with an application. For example, the application may generate its state (e.g., according to the primitive or function described above) and include the generated state in a message to the assistant application.

As a user manipulates or interacts with the application, the application may provide updates regarding its state. With respect to a tutorial related to building a code project, the application may reflect an IDE. For this example, the IDE may update (e.g., via pushes over the communication channel) the assistant application as a user uses the IDE. As an example, the IDE may indicate that the user has opened a new project. The IDE may indicate that the user has opened a new code file of the new project. The IDE may indicate that the user has entered some lines of code and triggered a build. These state updates may be provided by the IDE to the assistant application, for example based on updates generated by an internal primitive or function. Thus, in some embodiments the IDE (or generally, the application) may control when updates to state are to be provided to the assistant application.

Different techniques to establish a communication channel may be used and fall within the disclosure herein. For example, a broadcast channel may be established. As another example, web socket(s) may be used. As another example, innovative message passing schemes may be used such as described in U.S. Prov. Patent App. No. 63/750692 which is incorporated herein by reference in its entirety.

In some embodiments, the tutorial may be defined as including a multitude of individual steps each associated with validation information. With respect to the example of the IDE, validation information for a particular step related to opening a new project may indicate that the IDE state reflects a new project. For example, the IDE may be presenting a new project user interface or otherwise be in a state indicative of a user having triggered opening of a new project. The particular step may be defined based on potential state(s) of the IDE which satisfy the opening of the new project. For example, one potential state may indicate that the user triggered opening of a new project. As another example, one potential state may indicate that the user has navigated to the new project screen. As another example, one potential state may indicate that the user has utilized a terminal to open a new project. In general, the states described herein may be flexibly defined to encompass variations. As described above, in some embodiments an LLM may be used to analyze the state(s) being received from the IDE. Thus, the LLM may receive arbitrary information from the IDE and determine whether the particular step has been completed.

With respect to the LLM, a state of the above-described tutorial for the IDE may include a step to generate particular code. For example, the particular code may cause generation of a data object or object type associated with an ontology. In this example, the LLM may be relied upon, at least in part, to determine whether user-entered code causes generation of the data object or object type. Thus, to complete the step the assistant application may receive state(s) from the IDE reflecting that the user entered code and may then trigger analysis of the code to determine conformance with, or otherwise completion of, the step.

Tutorials may be substantially automatically generated, such that they may be rolled out to users to teach aspects of different application(s) or user flows through the application(s). As will be described, the LLM may analyze documentation associated with application(s) utilized by users. For example, an entity may have a software suite which is accessible to employees. As described herein, the software suite may include web applications although the techniques described herein are not so limited and may be used for standalone or native applications. The analysis may include incorporating all of, or aspects of, the documentation in a context window for input to the LLM as a prompt. The LLM may then determine steps, such as high-level, steps, towards completion of a goal that forms a tutorial.

The assistant application may interact with a user to generate the tutorial. For example, the user may indicate that the user wants to generate a particular tutorial that walks through particular features associated with application(s). As another example, the user may indicate that they are interested in the assistant application recommending potential tutorial topics (e.g., potential goals). As another example, the user may refine, or otherwise adjust, tutorial topics. For example, the assistant application may present a threshold number of potential tutorial topics. The user may then indicate interest in one of them, but then adjust the focus or goal associated with the tutorial of interest. In this way, the assistant application may be relied upon to focus in on tutorials of interest to the user.

As will be described, the assistant application may have access to a multitude of information. For example, a back-end associated with the assistant application (e.g., executing on a back-end system, such as system 100) may have access to the information. Example information may include application documentation such as manuals or other information related to use of applications. Example information may further include user onboarding information, such as any pre-written information that describes how users can perform actions or functions using the applications. Example information may further include access to chat logs, such as anonymized chat logs, with the assistant application. Chat logs may inform common user questions (e.g., ‘how do I do [X]’) or pain points (e.g., ‘when I try to do [X] I get this error’). With respect to access, the assistant application may surface relevant portions of this information for inclusion in a prompt the LLM. For example, the assistant application may use semantic search techniques to obtain relevant portions. As another example, the assistant application may use retrieval-augmented generation (RAG) techniques to obtain relevant portions.

Thus, the assistant application may present a high-level summary of steps associated with a tutorial indicated to be of interest by a user. To generate the tutorial, the LLM may then determine techniques by which each of the steps may be completed. As described above, the application(s) may include primitives or functions that enable generation of information reflecting application states. In some embodiments, the LLM may receive information reflecting possible states that each application (e.g., each application associated with a tutorial) may be in (e.g., all possible states). Thus, the LLM may output, for each step, techniques by which the step may be validated as completed (referred to herein as validation information).

In some embodiments, this validation information may be embodied in code or structured information. For example, validation information for a step may indicate a state, or states, that result in completion of the step. In this example, the assistant application may determine completion of the step based on receipt of the state or states. In some embodiments, the validation information may be embodied in text or prose that describes information indicating sufficient completion of the step. During implementation of the tutorial, the assistant application may leverage the LLM to determine whether text or prose has been met or otherwise satisfied.

The assistant application may validate a generated tutorial and optionally iterate upon the tutorial. For example, the generated tutorial may include steps each with validation information that validates completion based on context-aware use of application(s) implicated in the tutorial. The contextual awareness may be based on actual use of the applications(s), for example based on the received states. With respect to code or structured information, the LLM may ensure that the code or structured information is generated properly (e.g., compiles or interprets properly, with respect to code). The LLM may review any errors and iterate upon the tutorial.

In this way, the generated tutorial may leverage the power, and ease of use of, LLMs to enable rapid generation of accurate tutorials. As may be appreciated, tutorials may be quickly prepared based on an entity subscribing to, or otherwise making accessible, applications for use by users. During use of a tutorial, a user may ask questions of the assistant application (e.g., ‘I can’t figure out how to do [X] which seems to be required for this step’). The assistant application may leverage the LLM to output an answer which steers the user towards completion of the step.

The disclosed technology therefore improves upon existing tutorial techniques through use of actual contextual-awareness of a user progressing through the tutorial. The tutorial may be monitored based on application states or descriptive information indicative of use of the application. Additionally, tutorials may be quickly generated thus dramatically reducing a technical burden associated with analyzing applications and generating tutorials.

As may be appreciated, an LLM may analyze documentation associated with applications to determine steps. However, the LLM may additionally directly interact with applications to determine how to navigate through the application, perform specific functions, and so on. For example, the direct interactions may include the LLM receiving images or video of the application and outputting information (e.g., tokens) which cause a back-end system to provide user input, or otherwise control information, to the application. These direct interactions may be recorded and formed into documentation automatically by the LLM, such that tutorials for arbitrary applications may be generated with limited user input or guidance.

The above, and other, aspects, will now be described in more detail.

### Terms

In order to facilitate an understanding of the systems and methods discussed herein, a number of terms are defined below. The terms defined below, as well as other terms used herein, should be construed to include the provided definitions, the ordinary and customary meaning of the terms, and/or any other implied meaning for the respective terms. Thus, the definitions below do not limit the meaning of these terms, but only provide exemplary definitions.

Ontology: Stored information that provides a data model for storage of data in one or more databases. For example, the stored data may comprise definitions for data object types and respective associated property types. An ontology may also include respective link types/definitions associated with data object types, which may include indications of how data object types may be related to one another. An ontology may also include respective actions associated with data object types. The actions associated with data object types may include, e.g., defined changes to values of properties based on various inputs. An ontology may also include respective functions, or indications of associated functions, associated with data object types, which functions, e.g., may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types.

Data Store: Any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

Database: Any data structure (and/or combinations of multiple data structures) for storing and/or organizing data, including, but not limited to, relational databases (e.g., Oracle databases, PostgreSQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores.

Data Object or Object: A data container for information representing specific things in the world that have a number of definable properties. For example, a data object can represent an entity such as a person, a place, an organization, a market instrument, or other noun. A data object can represent an event that happens at a point in time or for a duration. A data object can represent a document or other unstructured data source such as an e-mail message, a news report, or a written paper or article. Each data object may be associated with a unique identifier that uniquely identifies the data object. The object’s attributes (e.g. metadata about the object) may be represented in one or more properties.

Object Type: Type of a data object (e.g., Person, Event, or Document). Object types may be defined by an ontology and may be modified or updated to include additional object types. An object definition (e.g., in an ontology) may include how the object is related to other objects, such as being a sub-object type of another object type (e.g. an agent may be a sub-object type of a person object type), and the properties the object type may have.

Properties: Attributes of a data object that represent individual data items. At a minimum, each property of a data object has a property type and a value or values.

Property Type: The type of data a property is, such as a string, an integer, or a double. Property types may include complex property types, such as a series data values associated with timed ticks (e.g. a time series), etc.

Property Value: The value associated with a property, which is of the type indicated in the property type associated with the property. A property may have multiple values.

Link: A connection between two data objects, based on, for example, a relationship, an event, and/or matching properties. Links may be directional, such as one representing a payment from person A to B, or bidirectional.

Link Set: Set of multiple links that are shared between two or more data objects.

### Block Diagrams

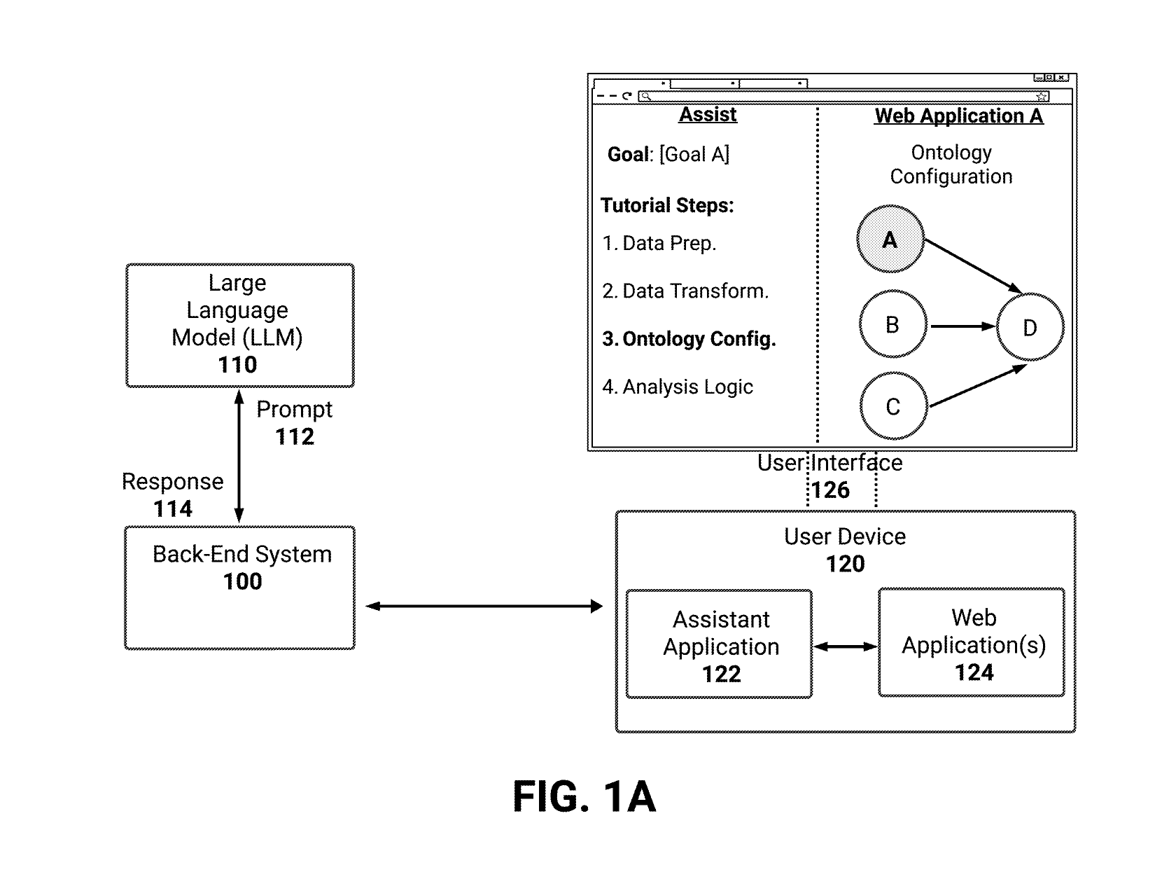

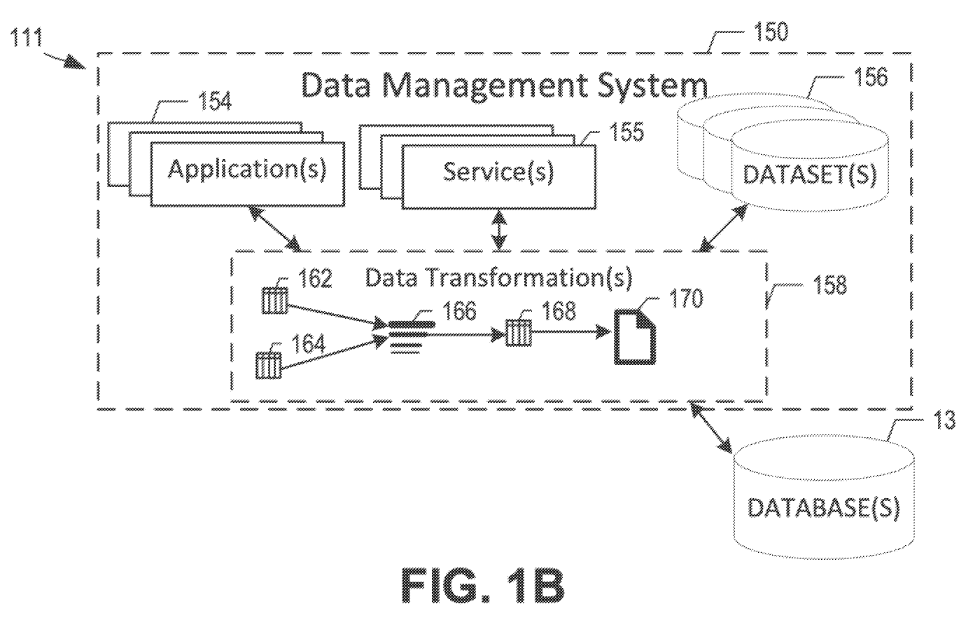

FIG. 1A is a block diagram of an example user device 120 executing an assistant application 122 and application(s) 124 in communication with a back-end system 100 and large language model (LLM) 110 for context-aware tutorials. The assistant application 122 and application(s) 124 may represent examples of web applications, such that the user device 120 is presenting front-ends (e.g., client-side versions) associated with the web applications (e.g., via a browser). While web applications are described herein, as may be appreciated the assistant application 122 and application(s) 124 may represent applications executing on the user device 120 (e.g., standalone applications, such as native applications).

In the illustrated example, the user device 120 is presenting a user interface 126 that includes an Assist portion (e.g., on the left) and Web Application A (e.g., on the right). In some embodiments, the Assist portion and Web Application A may be included in separate browser tabs or windows. With respect to user interface 126, the Assist portion and Web Application A are illustrated as being separate front-ends of applications 122-124. For example, the front-ends may be embedded in the respective portions (e.g., using iframes).

In some embodiments, the applications 122-124 may represent modules or portions of a larger application. The front-ends associated with the assistant application 122 and application(s) 124 may be composed together to form a cohesive user interface (e.g., interface 126). In the illustrated example, Web Application A is presenting a configuration screen or user interface associated with an ontology. In the illustrated example, multiple nodes are presented with links between the nodes. The nodes may represent, for example, object types associated with parameters, with links between the object types. A user may configure an object type, for example to specify parameters, and so on.

The back-end system 100 may implement back-end functionality associated with the assistant application 122 and application(s) 124. For example, the back-end system 100 may execute back-end functionality associated with Web Application A. In this example, the back-end system 100 may access or update data object, object types, an ontology, and so on.

The LLM 110 may represent a large language model which is executing on an external system or, in some embodiments, the back-end system 100. As known by those skilled in the art, a large language model may include a multitude of layers that include learnable parameters. There may be at least a threshold number of learnable parameters, such as 3 billion, 8 billion, 70 billion, 800 billion, 1 trillion, and so on. The layers may include, for example, transformer layers optionally with a mixture of experts (MoE) architecture. During inference, the LLM 110 uses embedding layer(s) to convert input (e.g., input tokens) into vector representations. These representations may then be processed through transformer layers and output layer(s), which generates output in an autoregressive manner. Example LLMs may include Large Language Model Meta AI (Llama), Qwen, Claude, generative pre-trained transformer (GPT) models, and so on. While LLMs are described, as may be appreciated other models may be used and fall within the scope of the disclosure herein (e.g., text diffusion language models).

As described herein, the assistant application 122 and application(s) 124 may communicate via communication channel(s). In some embodiments, the communication channel may be directional from the application(s) 124 to the assistant application 122. For example, the assistant application 122 may receive information (e.g., messages) from the application(s) 124. In this example, the application(s) 124 may push messages to the assistant application 122 (e.g., the assistant application 122 may subscribe to messages). In some embodiments, only an in-focus, or actively being presented, application (e.g., the application presenting Web Application A) may output messages to the assistant application 122.

An example message may indicate an application state, reflecting, for example, current configuration information associated with the application such as a currently presented user interface, recently received user input or actions, particular flags or statuses of the application, and so on. An example application state associated with Web Application A may indicate that the user is viewing an ontology configuration user interface. The application state may additionally identify actions a user of user interface 126 has taken (e.g., selected a node, input particular parameters, and so on). In FIG. 1A, the user has selected node ‘A’. The selection may represent user input provided to user interface 126, for example a cursor selection user keyboard, mouse, voice, touch-input, and so on.

Thus, the application state may reflect, for example, viewing of the ontology configuration user interface, selection of node ‘A’, and so on. This application state may be provided to the assistant application 122 via a message or other information over the communication channel described above.

In some embodiments, the application(s) 124 may provide messages to the assistant application 122 periodically or based on an update made to the application(s) 124. As an example, based on an update to the state (e.g., selection of node ‘A’) the application(s) 124 may provide message(s) to the assistant application 122. In this way, the assistant application 122 may maintain a substantially current indication of the user’s interactions with the Web Application A.

The assist portion is presenting an example tutorial which leverages, at least in part, Web Application A. For example, the assist portion includes information reflecting a goal associated with the tutorial (e.g., Goal A). The tutorial may have been selected from a list or set of tutorials available from the assistant application 122. In the illustrated example, the tutorial relates to techniques for configuring an ontology and then leveraging analysis logic on associated object data types. Specifically, the tutorial includes four steps: (1) a data preparation step, (2) a data transformation step, (3) an ontology configuration step, and (4) an analysis logic step. As will be described, these steps may have been generated by an LLM, such as LLM 110.

The user may additionally write, or otherwise provide, a question or query for the LLM 110. For example, the user may ask how to perform particular steps, sub-steps, or any question related to the tutorial. The LLM 110 may respond to the question, for example based on stored information associated with the tutorial. As an example, the LLM 110 may have access to documentation associated with Web Application A. For this example, the LLM 110 may receive all, or a relevant portion, of the documentation to respond to the user’s question.

In some embodiments, and as will be described below, each step may have one or more questions associated with it. For example, during generation of the tutorial particular questions (e.g., common questions) may be specified. The user interface 126 may present these questions for the user to easily select. For example, the assist portion may respond to user input to view the questions. As one example, the user may hover a mouse, or provide touch-input, to one of the steps. In response, the user interface 126 may update to present the questions. The user may also ask for (e.g., in a chat to the assistant application 122) common questions, and the assistant portion may update to include one or more of the questions.

The assistant application 122 may determine, or otherwise cause identification of, completion of the steps identified in user interface 126. For example, the web application associated with Web Application A may provide message(s) to the assistant application 122. As described above, the messages may reflect application state(s) and may be routed over a communication channel. In some embodiments, the messages may be passed between client-side applications (e.g., application 122-124).

The message(s) may be provided, as an example, via a broadcast channel. For example, the assistant application 122 may subscribe to updates or messages from the application(s) 124. In this example, the assistant application 122 may thus obtain message(s) reflecting that the user is viewing an ontology configuration user interface, that the user has selected object type A, and so on.

In some embodiments, the assistant application 122 and application(s) 124 may communicate with the back-end system 100 using respective web sockets. For example, upon interaction with object type A the application associated with Web Application A may provide information to the back-end system 100 (e.g., via a web socket) identifying the interaction. The back-end system 100 may then update the back-end of the assistant application 122 and provide, via a web socket, information identifying the interaction to the assistant application 122. In this way, application states associated with Web Application A may be routed to assistant application 122 using the back-end system 100.

Additional techniques to establish, and maintain, communications between the applications122-124 may be used and fall within the scope of the disclosure herein. For example, techniques described in U.S. Prov. Patent App. No. 63/750692, which is incorporated herein by reference in its entirety, may be used.

To monitor progression through the tutorial, the assistant application 122 may trigger analysis of the application state(s) from the web application(s) 124. The tutorial, as will be described, may be formed from code or other information that includes validation information for each of the steps. The validation information may reflect specific application state(s) that result in satisfaction of a step. For example, in the illustrated example the step is related to ontology configuration. In this example, the validation information may indicate that the step is completed based on receipt of an application state related to configuring node ‘A’. The validation information may also indicate that the step is completed based on receipt of user input indicating that the ontology configuration is to be saved or otherwise updated.

Each of the application(s) 124 may include executable code that causes generation of an application state. In some embodiments, the executable code may indicate a current application state from a multitude of possible application states. For example, there may be a schema or set of possible states and the application may generate a message based on an update to the state. With respect to the example of FIG. 1A, Web Application A may have states reflecting a currently viewed user interface, types of interactions with the underlying application, calls (e.g., network calls) to other applications (e.g., performed via back-end system 100), and so on.

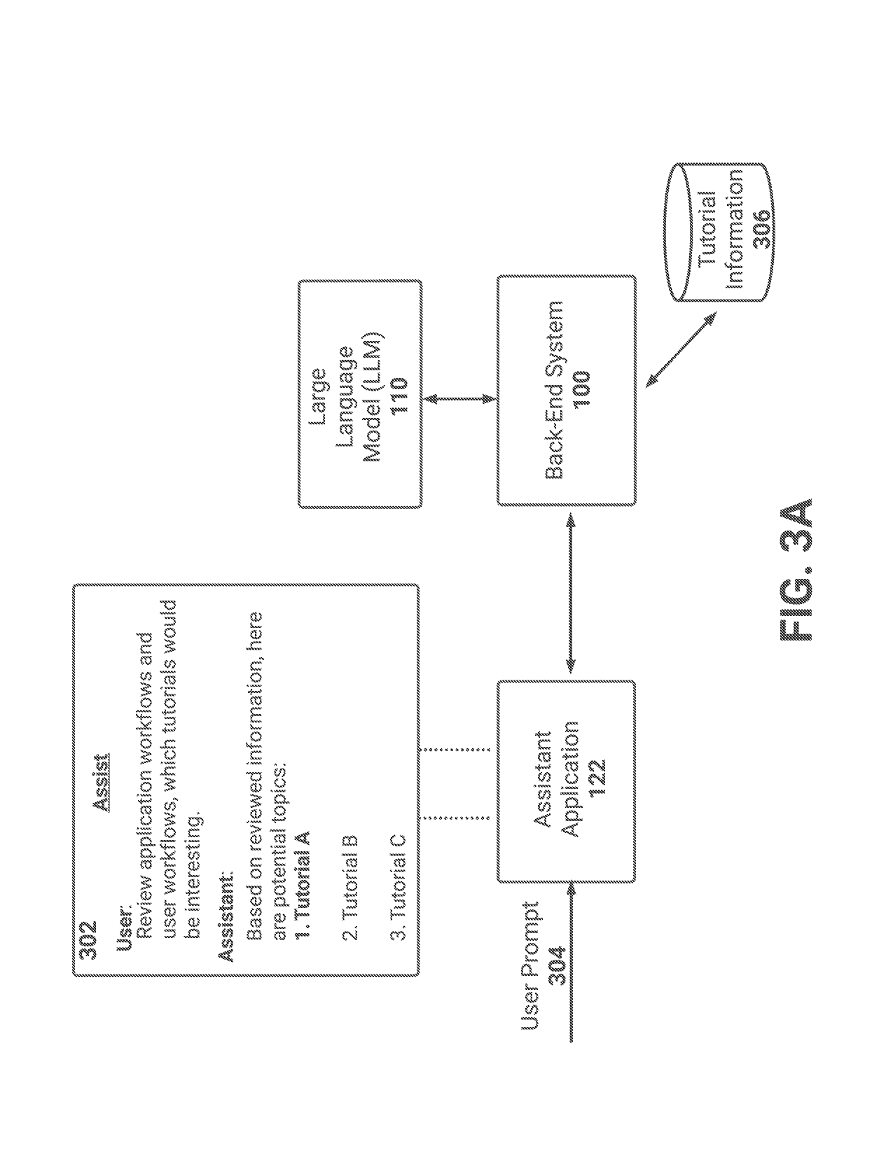

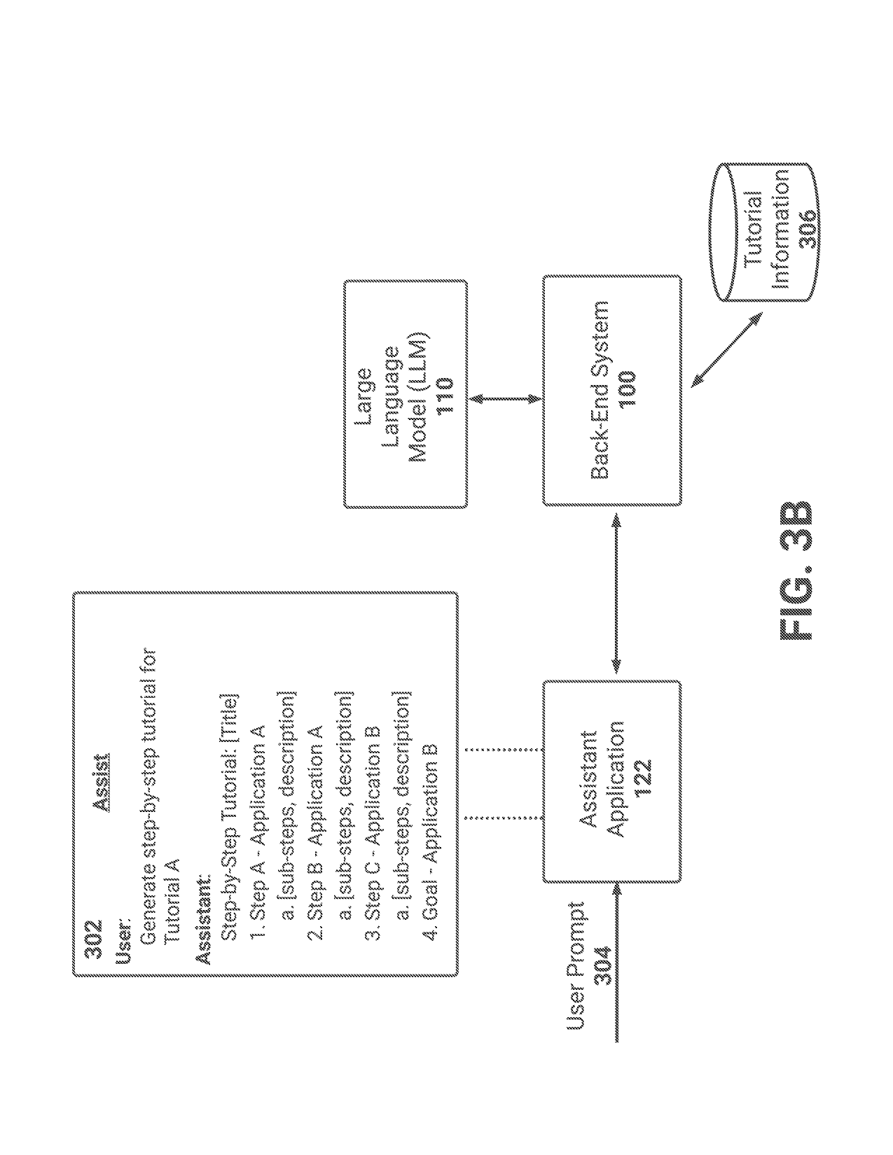

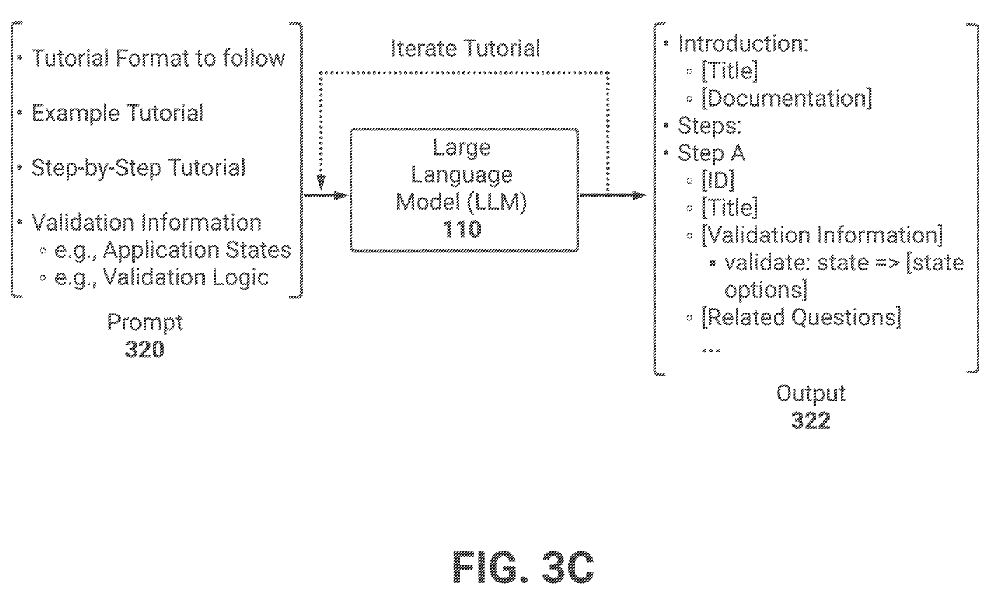

With respect to the above, the tutorial may define validation information that references the possible application states. Thus, the assistant application 122 may receive an application state and determine whether the current step is satisfied based on the state. In some embodiments, the client-side of the assistant application 122 may have information defining the tutorial. Example information defining a tutorial is illustrated in FIG. 3C. Thus, the client-side can determine satisfaction of a step based on an application state. In this way, the application state may be maintained in the user’s browser. In some embodiments, the back-end of the assistant application 122 (e.g., executing on back-end system 100) may determine satisfaction of a step. For example, the client-side of the assistant application 122 may provide the application state to the back-end system 100 for analysis.

The above described that each application can output its application state from a set of defined application states. In this way, when generating a tutorial, the tutorial can include validation information that references one or more of the application states. The assistant application 122 can therefore validate whether the step is completed based on actual operation of the application (e.g., Web Application A).

The LLM 110 may additionally validate completion of a step. For example, the back-end system 100 may form a prompt 112 that includes a definition of the tutorial, received application states, a history of progression through the tutorial (e.g., completion of steps 1-2), and so on. In this example, the LLM 110 may output a response 114 reflecting whether the user has completed the step. As will be described, in some embodiments the LLM 110 can recommend an additional application state for inclusion in the set of defined application states. For example, as new functionality is added to an application the LLM 110 may ascertain whether the set of defined application states is sufficient to encompass the new functionality.

In some embodiments, the application state may reflect raw information associated with operation of the application(s). For example, the code that forms the application(s) may include output statements, debug statements, and the like, that update internal information associated with the application. In this example, the raw information may indicate that the user has opened the ontology configuration user interface, has selected node ‘A’, has provided certain user input to edit or configure the associated object type. The raw information may additionally indicate internal operations of the application, such as information regarding processing of the user input, processing of the configurations, and so on. In some embodiments, the raw information may include images or video associated with use of Web Application A. For example, images may be periodically taken. As another example, images may be taken based on a user input update or an update of the user interface of Web Application.

With respect to the above, the LLM 110 may receive this raw information in a prompt 112 formed by back-end system 100. The LLM 110 may output a response 114 indicative of whether the raw information indicates completion of a step. For example, the raw information may be tagged with timestamps or be ordered according to time. In this example, the LLM 110 may understand progression through the application.

The LLM 110 may periodically receive a prompt 112 to determine completion of a step or may receive a prompt based on a determination by the assistant application 122 that the step has been completed. The LLM 110 may additionally receive a prompt 112 based on user input to the assist portion of user interface 126 indicating the user considers the step to have been completed.

The back-end system 100 may thus form a prompt 112 to be sent to the LLM 110. The prompt 112 may include, for example, a question from the user and the attached code (e.g., selected via user interface 126). As may be appreciated, the prompt 112 may additionally include system prompts (e.g., informing the LLM 110 how to respond, specifying guardrails, and so on), prior context, and so on.

The back-end system 100 may thus receive response 114 from the LLM 110. The response 114 may optionally be analyzed using one or more other LLMs, for example which implement guardrails. The back-end system 100 may provide the response to the assistant application 122 for inclusion in user interface 126.

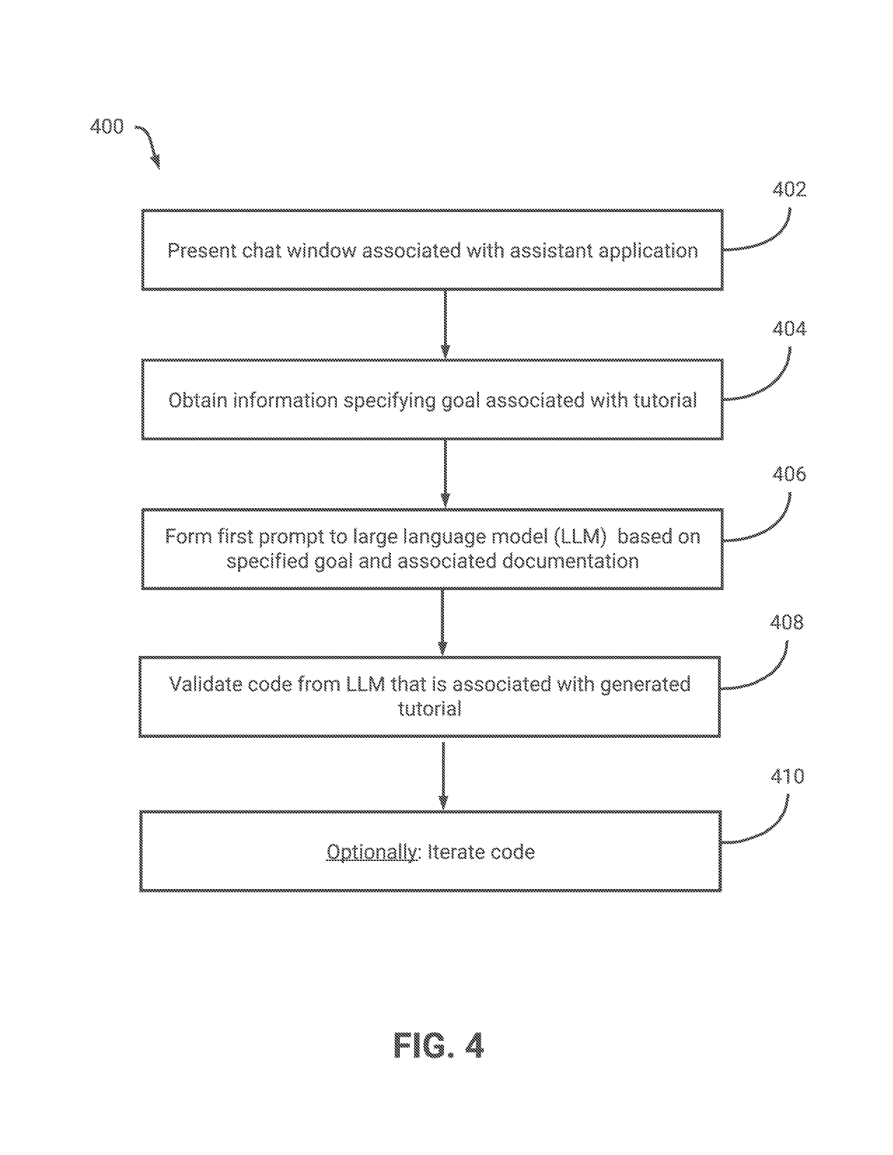

The user may thus continue through the tutorial performing steps and the assistant portion of user interface 126 can update to reflect completion of individual steps. Additionally, the user can provide questions for review by the LLM 110. In this way, the tutorial can be substantially interactive while guiding the user towards a goal and verifying completion thereof. The assist portion can output error messages or messages indicating the user has performed an incorrect action. In some embodiments, the error messages may be substantially standardized. For example, when generating the tutorial, for example as described below in FIG. 3A-4, the LLM 110 may generate error messages for common, or all anticipated, incorrect actions. In this way, all users associated with an entity may receive a same error message for a same incorrect action. In some embodiments, the LLM 110 may create the error messages during operation of the tutorial.

As part of traversing through the tutorial, the tutorial may require use of multiple applications. Thus, the user may cause subsequent web applications to open in user interface 126. Advantageously, each of the web applications may include functionality to output application state(s) to assistant application 122. In this way, complex tutorials that spread across applications can be generated and rolled out to end-users.

### Ontology Model

FIG. 1B illustrates an example data management system 150 for use with a back-end system (e.g., system 100), according to some embodiments of the present disclosure. In particular, the data management system 150 can be used with the back-end system 100 described above with respect to FIG. 1A. In the embodiments of FIG. 1B, a computing environment 111 can be similar to, overlap with, and/or be used in conjunction with the description of FIG. 1A. For example, the computing environment 111 can include a database 132. The computing environment 111 can also include a data management system 150.

The example data management system 150 includes one or more applications 154, one or more services 155, one or more initial datasets 156, and a data transformation process 158 (also referred to herein as a build process). The example data management system 150 can include a data pipeline system. The data management system 150 can transform data and record the data transformations. The one or more applications 154 can include applications that enable users to view datasets, interact with datasets, filter data sets, and/or configure dataset transformation processes or builds. The one or more services 155 can include services that can trigger the data transformation builds and API services for receiving and transmitting data. The one or more initial datasets 156 can be automatically retrieved from external sources and/or can be manually imported by a user. The one or more initial datasets 156 can be in many different formats such as a tabular data format (SQL, delimited, or a spreadsheet data format), a data log format (such as network logs), or time series data (such as sensor data).

The data management system 150, via the one or more services 155, can apply the data transformation process 158. An example data transformation process 158 is shown. The data management system 150 can receive one or more initial datasets 162, 164. The data management system 150 can apply a transformation to the dataset(s). For example, the data management system 150 can apply a first transformation 166 to the initial datasets 162, 164, which can include joining the initial datasets 162, 164 (such as or similar to a SQL JOIN), and/or a filtering of the initial datasets 162, 164. The output of the first transformation 166 can include a modified dataset 168. A second transformation of the modified dataset 168 can result in an output dataset 170, such as a report or a joined table in a tabular data format that can be stored in the database 132. Each of the steps in the example data transformation process 158 can be recorded by the data management system 150 and made available as a resource to the back-end 100. For example, a resource can include a dataset and/or a dataset item, a transformation, or any other step in a data transformation process. As mentioned above, the data transformation process or build 158 can be triggered by the data management system 150, where example triggers can include nightly build processes, detected events, or manual triggers by a user. Additional aspects of data transformations and the data management system 150 are described in further detail below.

The techniques for recording and transforming data in the data management system 150 may include maintaining an immutable history of data recording and transformation actions such as uploading a new dataset version to the data management system 150 and transforming one dataset version to another dataset version. The immutable history is referred to herein as “the catalog.” The catalog may be stored in a database. Preferably, reads and writes from and to the catalog are performed in the context of ACID-compliant transactions supported by a database management system. For example, the catalog may be stored in a relational database managed by a relational database management system that supports atomic, consistent, isolated, and durable (ACID) transactions.

The catalog can include versioned immutable “datasets.” More specifically, a dataset may encompass an ordered set of conceptual dataset items. The dataset items may be ordered according to their version identifiers recorded in the catalog. Thus, a dataset item may correspond to a particular version of the dataset. A dataset item may represent a snapshot of the dataset at a particular version of the dataset. As a simple example, a version identifier of ‘1’ may be recorded in the catalog for an initial dataset item of a dataset. If data is later added to the dataset, a version identifier of ‘2’ may be recorded in the catalog for a second dataset item that conceptually includes the data of the initial dataset item and the added data. In this example, dataset item ‘2’ may represent the current dataset version and is ordered after dataset item ‘1’.

As well as being versioned, a dataset may be immutable. That is, when a new version of the dataset corresponding to a new dataset item is created for the dataset in the system, pre- existing dataset items of the dataset are not overwritten by the new dataset item. In this way, pre-existing dataset items (i.e., pre-existing versions of the dataset) are preserved when a new dataset item is added to the dataset (i.e., when a new version of the dataset is created). Note that supporting immutable datasets is not inconsistent with pruning or deleting dataset items corresponding to old dataset versions. For example, old dataset items may be deleted from the system to conserve data storage space.

A version of dataset may correspond to a successfully committed transaction against the dataset. In these embodiments, a sequence of successfully committed transactions against the dataset corresponds to a sequence of dataset versions of the dataset (i.e., a sequence of dataset items of the dataset).

A transaction against a dataset may add data to the dataset, edit existing data in the dataset, remove existing data from the dataset, or a combination of adding, editing, or removing data. A transaction against a dataset may create a new version of the dataset (i.e., a new dataset item of the dataset) without deleting, removing, or modifying pre-existing dataset items (i.e., without deleting, removing, or modifying pre-existing dataset versions). A successfully committed transaction may correspond to a set of one or more files that contain the data of the dataset item created by the successful transaction. The set of files may be stored in a file system.

In the catalog, a dataset item of a dataset may be identified by the name or identifier of the dataset and the dataset version corresponding to the dataset item. In a preferred embodiment, the dataset version corresponds an identifier assigned to the transaction that created the dataset version. The dataset item may be associated in the catalog with the set of files that contain the data of the dataset item. In a preferred embodiment, the catalog treats the set of files as opaque. That is, the catalog itself may store paths or other identifiers of the set of files but may not otherwise open, read, or write to the files.

In sum, the catalog may store information about datasets. The information may include information identifying different versions (i.e., different dataset items) of the datasets. In association with information identifying a particular version (i.e., a particular dataset item) of a dataset, there may be information identifying one or more files that contain the data of the particular dataset version (i.e., the particular dataset item).

The catalog may store information representing a non-linear history of a dataset. Specifically, the history of a dataset may have different dataset branches. Branching may be used to allow one set of changes to a dataset to be made independent and concurrently of another set of changes to the dataset. The catalog may store branch names in association with dataset version identifiers for identifying dataset items that belong to a particular dataset branch.

The catalog may provide dataset provenance at the transaction level of granularity. As an example, suppose a transformation is executed in the data management system 150 multiple times that reads data from dataset A, reads data from dataset B, transforms the data from dataset A and the data from dataset B in some way to produce dataset C. As mentioned, this transformation may be performed multiple times. Each transformation may be performed in the context of a transaction. For example, the transformation may be performed daily after datasets and B are updated daily in the context of transactions. The result being multiple versions of dataset A, multiple versions of dataset B, and multiple versions of dataset C as a result of multiple executions of the transformation. The catalog may contain sufficient information to trace the provenance of any version of dataset C to the versions of datasets A and B from which the version of dataset C is derived. In addition, the catalog may contain sufficient information the trace the provenance of those versions of datasets A and B to the earlier versions of datasets A and B from which those versions of datasets A and B were derived.

The provenance tracking ability is the result of recording in the catalog for a transaction that creates a new dataset version, the transaction or transactions that the given transaction depends on (e.g., is derived from). The information recorded in the catalog may include an identifier of each dependent transaction and a branch name of the dataset that the dependent transaction was committed against.

According to some embodiments, provenance tracking extends beyond transaction level granularity to column level granularity. For example, suppose a dataset version A is structured as a table of two columns and a dataset version B is structured as a table of five columns. Further assume, column three of dataset version B is computed from column one of dataset version A. In this case, the catalog may store information reflecting the dependency of column three of dataset version B on column one of dataset version A.

The catalog may also support the notion of permission transitivity. For example, suppose the catalog records information for two transactions executed against a dataset referred to in this example as “Transaction 1” and Transaction 2.” Further suppose a third transaction is performed against the dataset which is referred to in this example as “Transaction 3.” Transaction 3 may use data created by Transaction 1 and data created by Transaction 2 to create the dataset item of Transaction 3. After Transaction 3 is executed, it may be decided according to organizational policy that a particular user should not be allowed to access the data created by Transaction 2. In this case, as a result of the provenance tracking ability, and in particular because the catalog records the dependency of Transaction 3 on Transaction 2, if permission to access the data of Transaction 2 is revoked from the particular user, permission to access the data of Transaction 3 may be transitively revoked from the particular user.

The transitive effect of permission revocation (or permission grant) can apply to an arbitrary number of levels in the provenance tracking. For example, returning to the above example, permission may be transitively revoked for any transaction that depends directly or indirectly on the Transaction 3.

According to some embodiments, where provenance tracking in the catalog has column level granularity. Then permission transitivity may apply at the more fine-grained column level. In this case, permission may be revoked (or granted) on a particular column of a dataset and based on the column-level provenance tracking in the catalog, permission may be transitively revoked on all direct or indirect descendent columns of that column.

A build service can manage transformations which are executed in the system to transform data. The build service may leverage a directed acyclic graph data (DAG) structure to ensure that transformations are executed in proper dependency order. The graph can include a node representing an output dataset to be computed based on one or more input datasets each represented by a node in the graph with a directed edge between node(s) representing the input dataset(s) and the node representing the output dataset. The build service traverses the DAG in dataset dependency order so that the most upstream dependent datasets are computed first. The build service traverses the DAG from the most upstream dependent datasets toward the node representing the output dataset rebuilding datasets as necessary so that they are up-to-date. Finally, the target output dataset is built once all of the dependent datasets are up-to-date.

The data management system 150 can support branching for both data and code. Build branches allow the same transformation code to be executed on multiple branches. For example, transformation code on the master branch can be executed to produce a dataset on the master branch or on another branch (e.g., the develop branch). Build branches also allow transformation code on a branch to be executed to produce datasets on that branch. For example, transformation code on a development branch can be executed to produce a dataset that is available only on the development branch. Build branches provide isolation of re-computation of graph data across different users and across different execution schedules of a data pipeline. To support branching, the catalog may store information represents a graph of dependencies as opposed to a linear dependency sequence.

The data management system 150 may enable other data transformation systems to perform transformations. For example, suppose the system stores two “raw” datasets R1 and R2 that are both updated daily (e.g., with daily web log data for two web services). Each update creates a new version of the dataset and corresponds to a different transaction. The datasets are deemed raw in the sense that transformation code may not be executed by the data management system 150 to produce the datasets. Further suppose there is a transformation A that computes a join between datasets R1 and R2. The join may be performed in a data transformation system such a SQL database system, for example. More generally, the techniques described herein are agnostic to the particular data transformation engine that is used. The data to be transformed and the transformation code to transform the data can be provided to the engine based on information stored in the catalog including where to store the output data.

According to some embodiments, the build service supports a push build. In a push build, rebuilds of all datasets that depend on an upstream dataset or an upstream transformation that has been updated are automatically determined based on information in the catalog and rebuilt. In this case, the build service may accept a target dataset or a target transformation as an input parameter to a push build command. The build service than determines all downstream datasets that need to be rebuilt, if any.

As an example, if the build service receives a push build command with dataset R1 as the target, then the build service would determine all downstream datasets that are not up-to-date with respect to dataset R1 and rebuild them. For example, if dataset D1 is out-of-date with respect to dataset R1, then dataset D1 is rebuilt based on the current versions of datasets R1 and R2 and the current version of transformation A. If dataset D1 is rebuilt because it is out-of-date, then dataset D2 will be rebuilt based on the up-to-date version of dataset D1 and the current version of transformation B and so on until all downstream dataset of the target dataset are rebuilt. The build service may perform similar rebuilding if the target of the push build command is a transformation.

The build service may also support triggers. In this case, a push build may be considered a special case of a trigger. A trigger, generally, is a rebuild action that is performed by the build service that is triggered by the creation of a new version of a dataset or a new version of a transformation in the system.

A schema metadata service can store schema information about files that correspond to transactions reflected in the catalog. An identifier of a given file identified in the catalog may be passed to the schema metadata service and the schema metadata service may return schema information for the file. The schema information may encompass data schema related information such as whether the data in the file is structured as a table, the names of the columns of the table, the data types of the columns, user descriptions of the columns, etc.

The schema information can be accessible via the schema metadata service may versioned separately from the data itself in the catalog. This allows the schemas to be updated separately from datasets and those updates to be tracked separately. For example, suppose a comma separated file is uploaded to the system as particular dataset version. The catalog may store in association with the particular dataset version identifiers of one or more files in which the CSV data is stored. The catalog may also store in association with each of those one or more file identifiers, schema information describing the format and type of data stored in the corresponding file. The schema information for a file may be retrievable via the scheme metadata service given an identifier of the file as input. Note that this versioning scheme in the catalog allows new schema information for a file to be associated with the file and accessible via the schema metadata service. For example, suppose after storing initial schema information for a file in which the CSV data is stored, updated the schema information is stored that reflects a new or better understanding of the CSV data stored in the file. The updated schema information may be retrieved from the schema metadata service for the file without having to create a new version of the CSV data or the file in which the CSV data is stored.

When a transformation is executed, the build service may encapsulate the complexities of the separate versioning of datasets and schema information. For example, suppose transformation A described above in a previous example that accepts the dataset R1 and dataset R2 as input is the target of a build command issued to the build service. In response to this build command, the build service may determine from the catalog the file or files in which the data of the current versions of datasets R1 and R2 is stored. The build service may then access the schema metadata service to obtain the current versions of the schema information for the file or files. The build service may then provide all of identifiers or paths to the file or files and the obtained schema information to the data transformation engine to execute the transformation A. The underlying data transformation engine interprets the schema information and applies it to the data in the file or files when executing the transformation A.

To provide a framework for the following discussion of specific systems and methods described herein, an example database system 210 using an ontology 205 will now be described. This description is provided for the purpose of providing an example and is not intended to limit the techniques to the example data model, the example database system, or the example database system’s use of an ontology to represent information.

In one embodiment, a body of data is conceptually structured according to an object-centric data model represented by ontology 205. The conceptual data model is independent of any particular database used for durably storing one or more database(s) 209 based on the ontology 205. For example, each object of the conceptual data model may correspond to one or more rows in a relational database or an entry in Lightweight Directory Access Protocol (LDAP) database, or any combination of one or more databases.

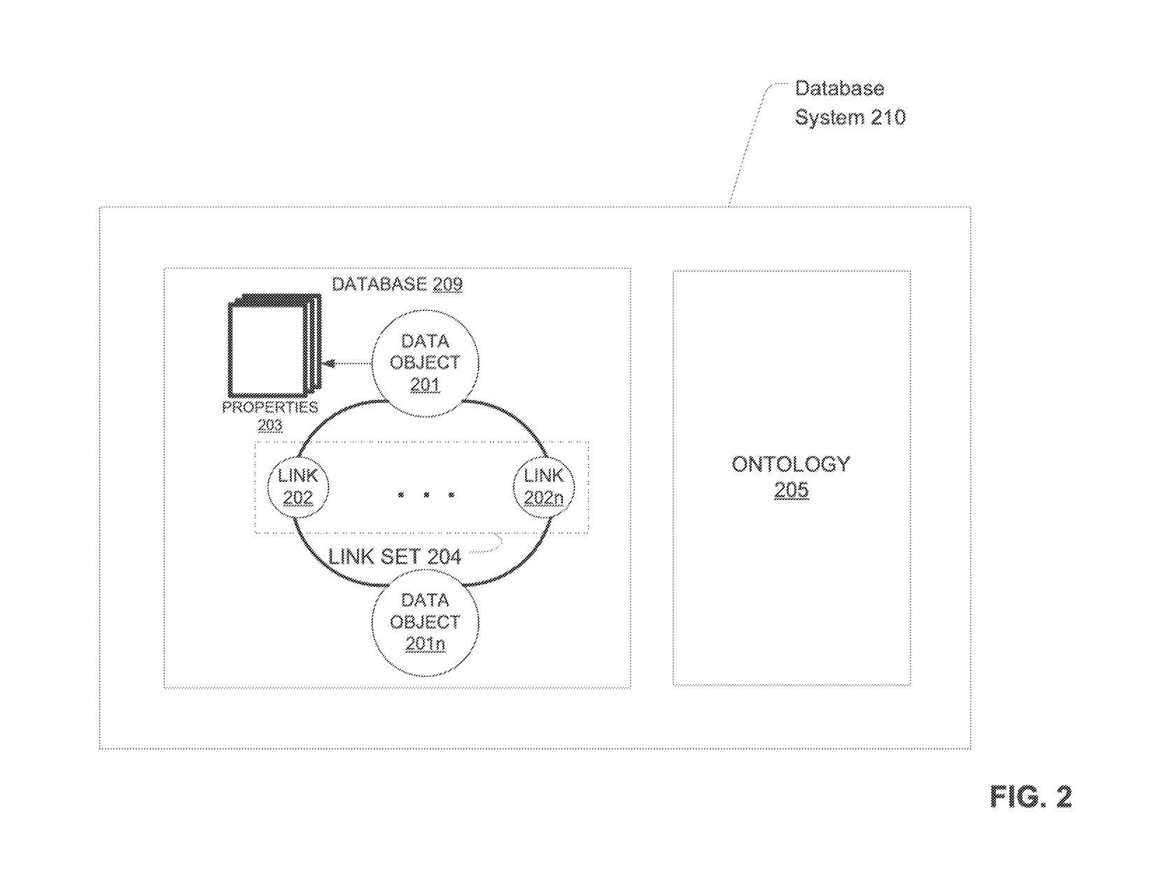

FIG. 2 illustrates an object-centric conceptual data model according to an embodiment. An ontology 205, as noted above, may include stored information providing a data model for storage of data in the database 209. The ontology 205 may be defined by one or more object types, which may each be associated with one or more property types. At the highest level of abstraction, data object 201 is a container for information representing things in the world. For example, data object 201 can represent an entity such as a person, a place, an organization, a market instrument, or other noun. Data object 201 can represent an event that happens at a point in time or for a duration. Data object 201 can represent a document or other unstructured data source such as an e-mail message, a news report, or a written paper or article. Each data object 201 is associated with a unique identifier that uniquely identifies the data object within the database system.

Different types of data objects may have different property types. For example, a “Person” data object might have an “Eye Color” property type and an “Event” data object might have a “Date” property type. Each property 203 as represented by data in the database system 210 may have a property type defined by the ontology 205 used by the database 205.

Objects may be instantiated in the database 209 in accordance with the corresponding object definition for the particular object in the ontology 205. For example, a specific monetary payment (e.g., an object of type “event”) of US$30.00 (e.g., a property of type “currency”) taking place on 3/27/2009 (e.g., a property of type “date”) may be stored in the database 209 as an event object with associated currency and date properties as defined within the ontology 205. The data objects defined in the ontology 205 may support property multiplicity. In particular, a data object 201 may be allowed to have more than one property 203 of the same property type. For example, a “Person” data object might have multiple “Address” properties or multiple “Name” properties.

Each link 202 represents a connection between two data objects 201. In one embodiment, the connection is either through a relationship, an event, or through matching properties. A relationship connection may be asymmetrical or symmetrical. For example, “Person” data object A may be connected to “Person” data object B by a “Child Of” relationship (where “Person” data object B has an asymmetric “Parent Of” relationship to “Person” data object A), a “Kin Of” symmetric relationship to “Person” data object C, and an asymmetric “Member Of” relationship to “Organization” data object X. The type of relationship between two data objects may vary depending on the types of the data objects. For example, “Person” data object A may have an “Appears In” relationship with “Document” data object Y or have a “Participate In” relationship with “Event” data object E. As an example of an event connection, two “Person” data objects may be connected by an “Airline Flight” data object representing a particular airline flight if they traveled together on that flight, or by a “Meeting” data object representing a particular meeting if they both attended that meeting. In one embodiment, when two data objects are connected by an event, they are also connected by relationships, in which each data object has a specific relationship to the event, such as, for example, an “Appears In” relationship.

As an example of a matching properties connection, two “Person” data objects representing a brother and a sister, may both have an “Address” property that indicates where they live. If the brother and the sister live in the same home, then their “Address” properties likely contain similar, if not identical property values. In one embodiment, a link between two data objects may be established based on similar or matching properties (e.g., property types and/or property values) of the data objects. These are just some examples of the types of connections that may be represented by a link and other types of connections may be represented; embodiments are not limited to any particular types of connections between data objects. For example, a document might contain references to two different objects. For example, a document may contain a reference to a payment (one object), and a person (a second object). A link between these two objects may represent a connection between these two entities through their co-occurrence within the same document.

Each data object 201 can have multiple links with another data object 201 to form a link set 204. For example, two “Person” data objects representing a husband and a wife could be linked through a “Spouse Of” relationship, a matching “Address” property, and one or more matching “Event” properties (e.g., a wedding). Each link 202 as represented by data in a database may have a link type defined by the database ontology used by the database.

### Tutorial Generation

FIGS. 3A-4 describe techniques to generate a tutorial using, at least in part, a large language model (LLM). The tutorial, as described herein, may include individual steps which are capable of validation or verification. For example, the steps may relate to use of one or more applications (e.g., web application, standalone or native applications). In this example, the steps may be validated or verified based on information reflecting use of the applications (referred to herein as application state(s)). The below describes examples of generating such a contextually aware tutorial in a substantially automated way, such that complex tutorials that walk through arbitrarily complex flows can be rapidly generated.

FIG. 3A is a block diagram illustrating detail of the assistant application 122 presenting summary information associated with an example tutorial. In the illustrated example, an assist user interface 302 is presenting a chat between a user and an assistant. The user has provided user prompt 304 that includes text, “Review application workflows and user workflows, which tutorials would be interesting.” The assistant may represent an intelligent assistant powered by LLM 110.

Specifically, the chat indicates that the user wants the assistant to review application workflows and user workflows to recommend corresponding tutorials. The assistant application 122 presenting the user interface 302 may represent a client-side web application. The back-end system 100 may execute a back-end of the application 122. Thus, the user prompt 304 may be routed to the LLM 110 as a prompt. In addition, the back-end system 100 may analyze database(s) (e.g., represented generally as tutorial information 306) to determine information relevant for the prompt to the LLM 110.

As an example, the back-end system 100 may execute a semantic search to find application workflows and user workflows. The back-end system 100 may use retrieval-augmented generation (RAG) to similarly find responsive information. The search may return documentation or other information that informs specific workflows for disparate applications accessible to users. The search may also return documentation or other information that informs specific user workflows. The user workflow may inform specific useful actions which may spread across applications. As an example, a user may generate code using a first application, generate front-end user interface elements using a second application, and trigger a build that combined the code and elements using a third application.

The back-end system 100 may additionally surface common user actions across applications. For example, the back-end system 100 may record metrics associated with use of applications. Example metrics may indicate common application functionality. The back-end system 100 may additionally identify common actions which are associated with questions by users to the LLM 110. For example, users may ask questions of the LLM 110 when using applications. In this example, the LLM 110 may respond to the questions based on documentation or other information associated with the applications. Common questions may correspond to tutorials which may provide substantial benefit to users.

In some embodiments, the LLM 110 may receive the user prompt 304 and output information or instructions to the back-end system 100. For example, the information or instructions may reflect types of information the LLM 110 has determined to be useful to responding to the prompt 304. The back-end system 100 can then search for the information and aggregate it into a prompt to be routed back to the LLM 110. For example, the prompt 110 may include the user prompt, the LLM 110 output information or instructions, and the responsive aggregated information.

In some embodiments, the back-end system 100 may execute an LLM to determine information to be provided to the LLM 110. For example, the executed LLM may represent a smaller parameter model (e.g., 2 billion parameters, 8 billion parameters) which analyzes the prompt 304 and outputs information to search. In this way, back-end system 100 may perform an intelligent search for information likely to be relevant to servicing the user prompt 304.

In FIG. 3A, the LLM 110 has identified three example tutorial topics. Each topic may optionally be associated with a particular goal, such as performing specific functionality, completing a flow through one or more applications, learning subtleties of an application, and so on. In the example, the user has selected that Tutorial A is of interest and is to be generated.

FIG. 3B is a block diagram illustrating detail of the assistant application 122 presenting steps associated with the example tutorial. As described in FIG. 3A, the user has selected Tutorial A to be generated for use by end-users. Thus, the assist user interface 302 has updated to present steps which form Tutorial A.

The steps may be determined, at least in part, by the LLM 110. Once Tutorial A is selected, the back-end system 100 may form a prompt to the LLM 110 that identifies the chat history and includes information relevant to determining the tutorial. As described above, the included information may be determined by the back-end system 100 using search techniques, such as semantic search, retrieval-augmented generation (RAG), and so on.

The LLM 110 may reason about logic required to achieve the tutorial goal. For example, the information input into the LLM’s 110 context window may include application manuals, documentation, website or forum posts relevant to achieving goals with applications, actual user flows that were recorded and which included or ended up achieving the tutorial goal, and so on. The LLM 110 can thus output higher-level steps that end up at the goal of the Tutorial A.

In some embodiments, the LLM 110 may be refined or undergo reinforcement learning training to effectively generate such step-by-step tutorials. For example, reinforcement learning may be used to move the LLM 110 towards generating high-level step-by-step ordered summaries based on disparate information related to applications. In this example, the reinforcement learning may additionally inform a specific output format. In some embodiments, a system prompt may instruct the LLM 110 to output the higher-level summary in numbered steps according to a particular format.

In the illustrated example, the LLM 110 has output individual steps and indicated which application the individual steps use. For example, steps A-B use Application A while steps 3-4 use Application B. As described herein, the applications may represent web applications or standalone applications (e.g., application(s) 124). Below each higher-level step (e.g., steps 1-4) the user interface 302 includes sub-steps and/or descriptions of the step. The description may indicate actions the user is to perform to complete the step.

For example, a step may include ‘Parse and clean data’. In this example, the description may indicate, ‘use [Library A] to parse, clean, and convert vector data formats into datasets.’ The associated application may represent a code editor, such as an integrated development environment (IDE). The indicated library may be preferable for use, or required for use, by an entity associated with the assistant application 122. In some embodiments, the user interface 302 may provide a user prompt 304 that requests whether a different library is acceptable. The LLM 110 may analyze the different library and determine whether it can complete the step. For example, and with respect to an ontology as described herein, Library A may include functionality which can configure or adjust data objects in accordance with the ontology. The LLM 110 may thus respond noting that the user’s different library will not result in completion of the step and include explanations as to why. Alternatively, the LLM 110 may determine that the different library is acceptable. The LLM 110 may then update the high-level summary to indicate that more than library may be used (e.g., the description may specify Library A along with the different library).

In some embodiments, the user of user interface 302 may leverage a private or custom agentic LLM 110. For example, the LLM 110 may represent an intelligent agent which is used by the user, or which is specific to a team associated with the user. The agent may thus have access to preferences or customizations which are specific to the user or the team. Thus, the steps may conform to these preferences or customizations. As an example, the preferences or customizations may indicate a particular version of Application A. As another example, particular libraries, for example private or otherwise preferred libraries, may be specified for use.

Additionally, the applications may optionally represent third-party applications. For example, a custom agent may have information indicating that the user or user’s team prefers to use a third-party application (e.g., web application) rather than one associated with an entity that controls the back-end system 100. As an example, the third-party application may have a back-end executing on a system different than back-end system 100. For this example, the LLM 110 may include the third-party application in the tutorial along with a description reflecting specific actions that are to be taken. As described herein, in some embodiments each application may output information reflecting its application state. The third-party application may not include the primitive or function described herein which outputs such information. However, as will be described in some embodiments a wrapper may be used to extract such information. Additionally, in some embodiments images or video may be obtained of the third-party application and the LLM can determine whether the specific actions have been performed.

FIG. 3C is a block diagram illustrating the LLM iteratively generating the example tutorial. The step-by-step tutorial described in FIG. 3B may be converted into code required to have an interactive tutorial as described herein. The code may reflect executable code or structured information which is used to monitor progression through the tutorial once generated.

In FIG. 3C, a prompt 320 is generated (e.g., by back-end system 100) and provided to the LLM 110. The prompt 320 may include example information, including a tutorial format to follow. The format may reflect structured information (e.g., JavaScript Object Notation) for the LLM 110 to follow. In addition, the prompt 320 may include an example tutorial which was previously generated and approved for use by end-users. The prompt 320 may include the step-by-step information determined in FIG. 3B.

In addition, the prompt 320 may include validation information in some embodiments. As described herein, the applications may include code which causes generation of application states. These application states may be provided to the assistant application (e.g., application 122) as part of a process by which a step may be validated. Optionally, the prompt 320 may include application states in which the applications implicated in the tutorial can be. For example, the included information may include information identifying each application (e.g., an application ID) along with the possible states. In some embodiments, each possible state may include explanatory information such as from documentation, manuals, and so on. Additionally, the states may be referenced in the previously generated tutorial such that the LLM 110 can reason about how the states are used.

The validation information may optionally include validation logic, such as descriptions of specific actions which are to be performed. In some embodiments, the validation logic may reflect raw information which is known to be associated with a particular action. For example, and with respect to the application being an IDE, the raw information may indicate individual user actions which result in a particular action by the IDE. The raw information may further indicate internally generated data, such as via output statements, debug statements, and so on as described herein.

In some embodiments, explicit validation information may not be provided in the prompt 320. Rather, during implementation of a tutorial the LLM 110 may analyze application states, raw information, images or video, and so on to ascertain completion of a step.

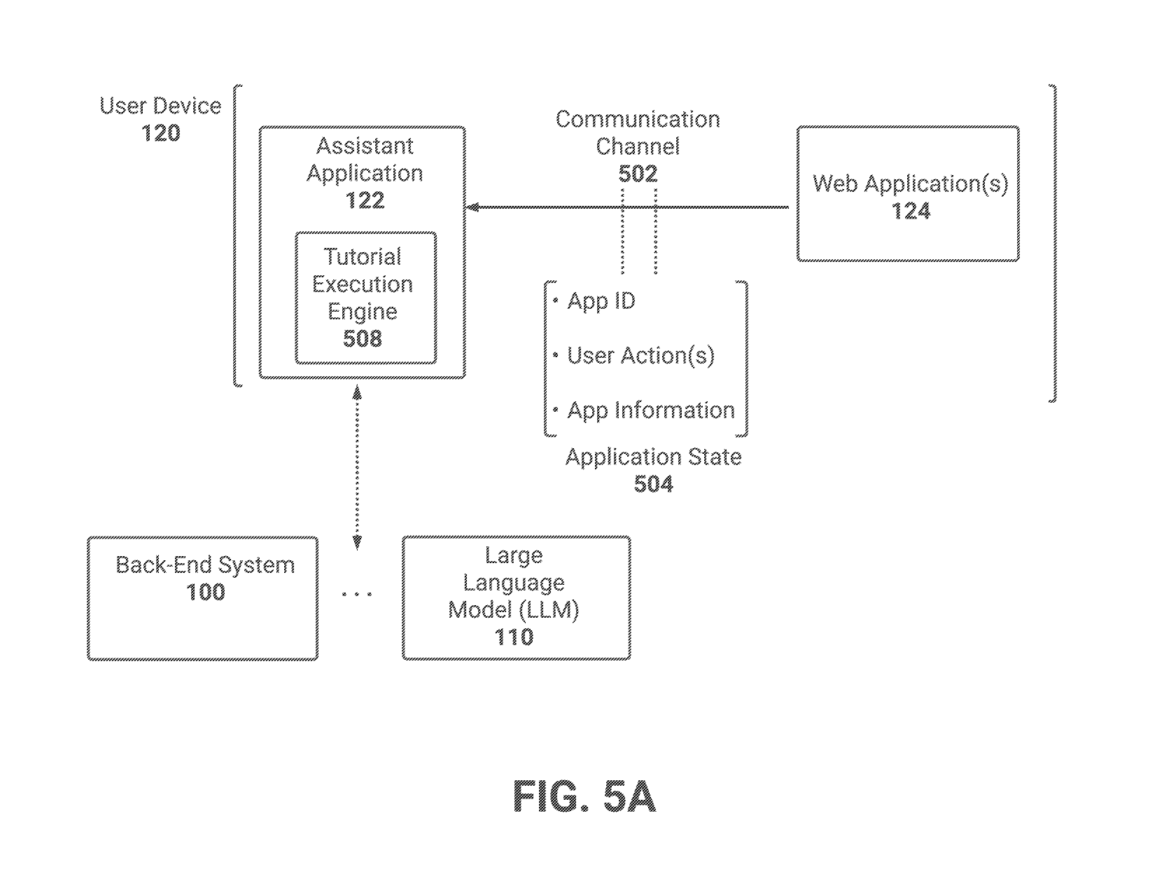

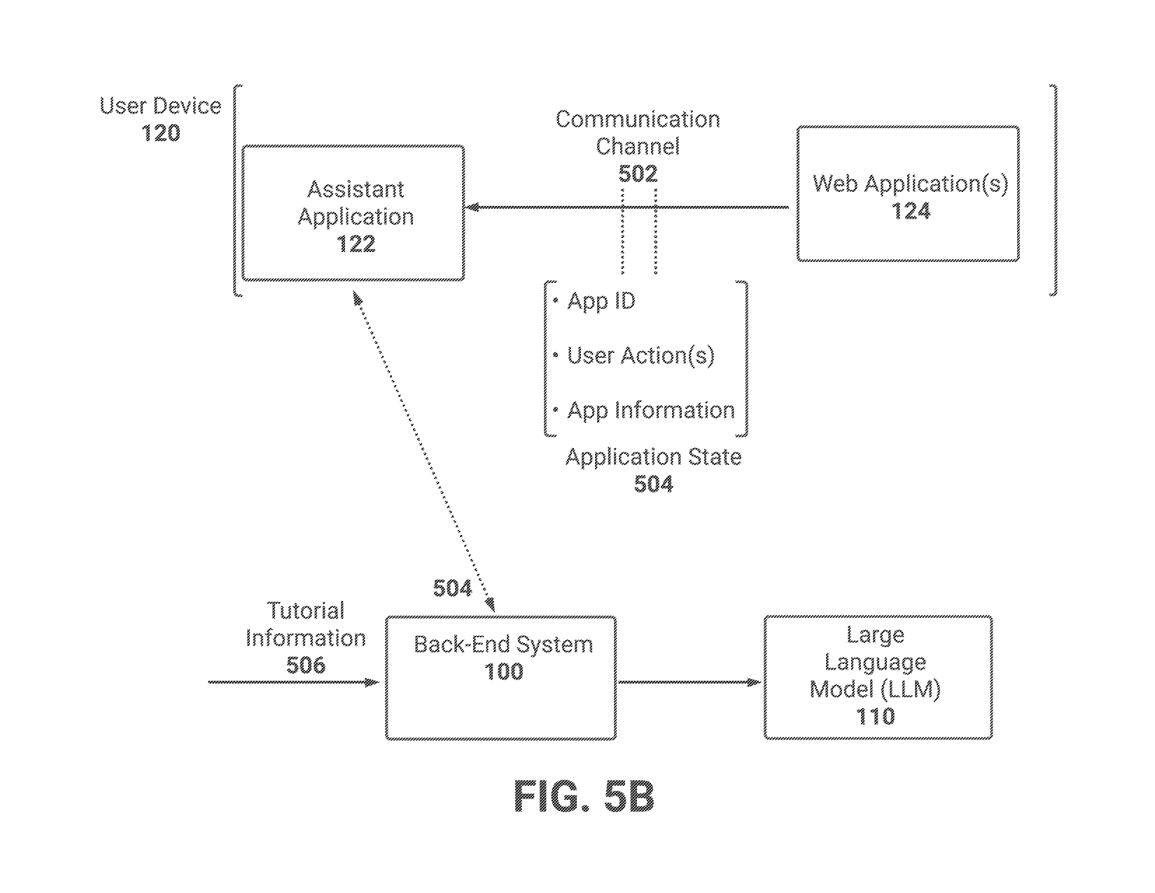

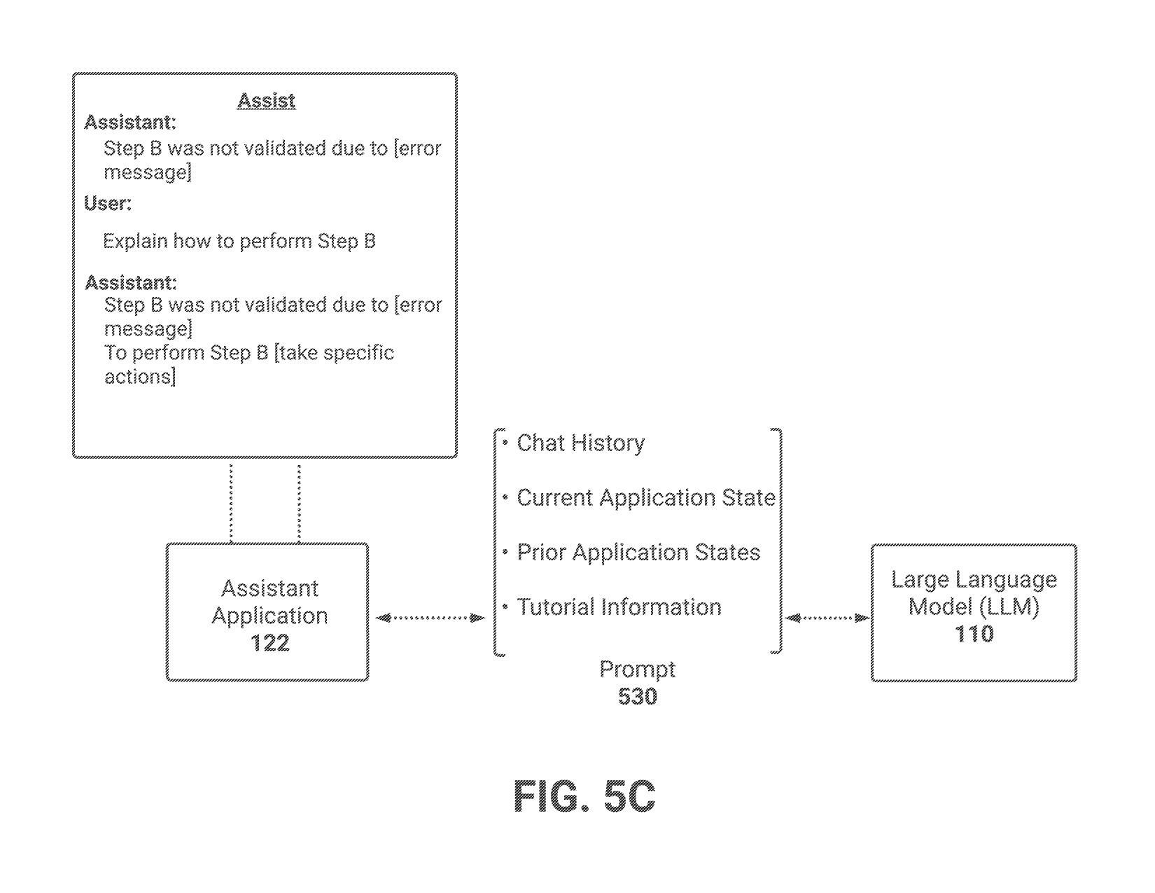

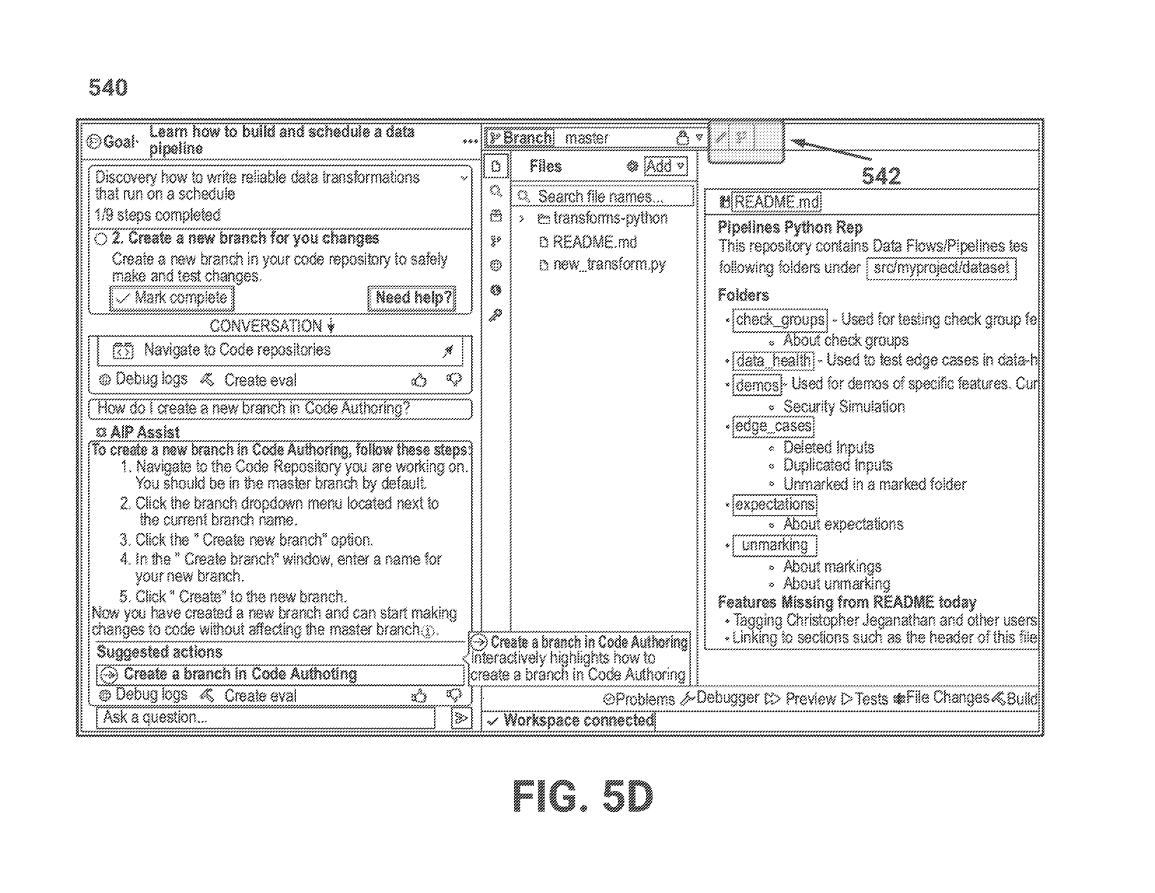

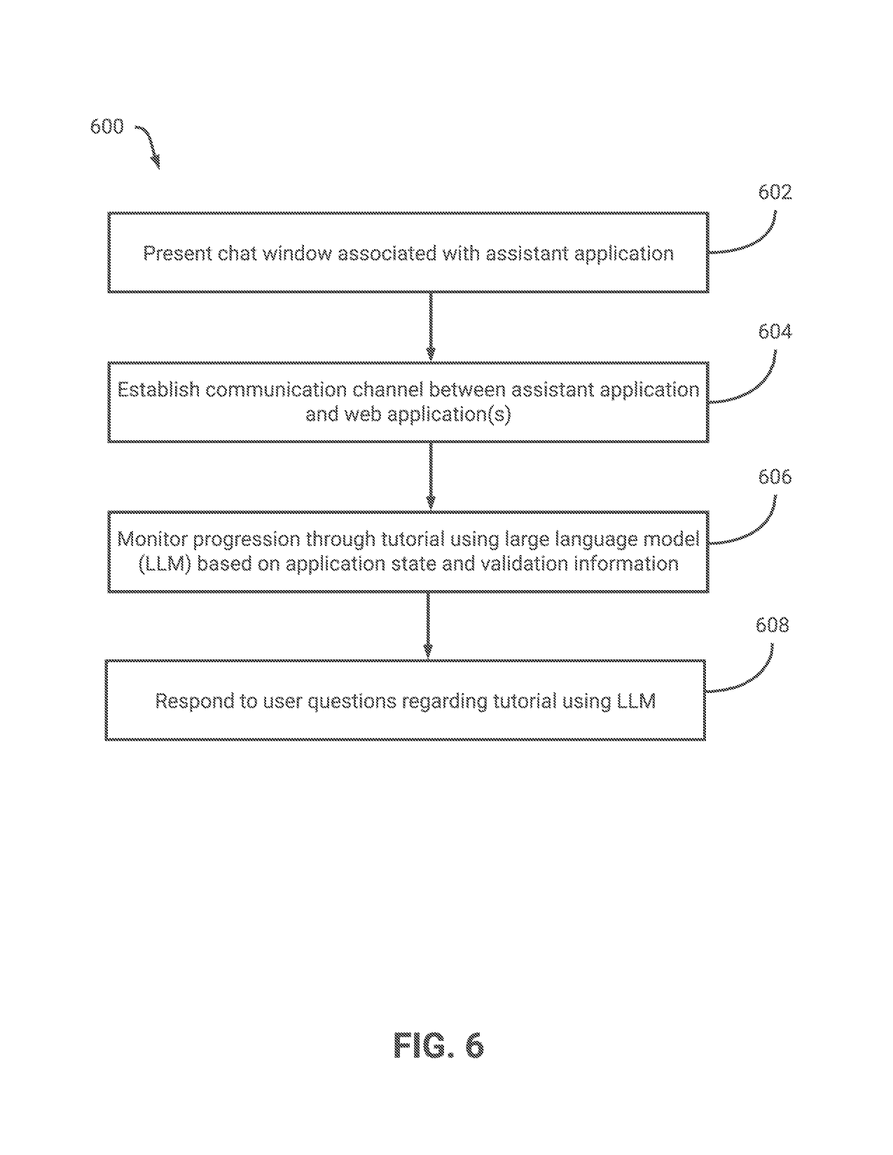

In the illustrated example, the LLM 110 has generated output 322 reflecting the tutorial. The output 322 follows the particular tutorial format indicated in the prompt 320. As will be described at least in FIGS. 5A-6, the assistant application may read in the tutorial (e.g., output 322) and enable an end-user to step through the tutorial towards the indicated goal. For example, the LLM 110 may receive the tutorial (e.g., in a prompt) and summarize it in a chat window accessible to the end-user.

The example format includes an introduction that specifies a title and associated documentation. This title may be presented by the assistant application when the tutorial is being performed by a user. Similarly, the tutorial includes an indication of steps (e.g., steps A-D as described in FIG. 3A). The assistant application may summarize these steps in the above-described chat window. Each step, the illustrated example, includes validation information. For example, the validation information may indicate application state(s) which are associated with completion of the step.

In some embodiments, related questions may be specified in the output 322. These questions may be generated by the LLM 110 and reflect common questions or questions expected to be of use to end-users. As described in FIG. 1A, an end-user may view these questions and the LLM 110 may generate a response upon selection of a question.

The output 322 may represent code in some implementations. For example, when an end-user is using the tutorial, the code may be run to validate completion of individual steps. As described above, the application(s) may output application states. Thus, the illustrated code may read int eh application states and determine whether individual states have been completed. In these implementations, the code included in the output 322 may optionally be type safe. Thus, the code may be interpreted or compiled and the LLM 110 may address any errors. For example, the validation information may reflect application states. In this example, the application states may be assured to exist for specific applications implicated in the tutorial. The LLM 110 may therefore iterate upon the output 322 until a final version of the tutorial is generated. In some embodiments, the LLM 110 may then implement the tutorial and, acting as a user, ensure that the tutorial is capable of being completed.

FIG. 4 is a flowchart of an example process 400 for generating, and validating, an example tutorial. For convenience, the process 400 will be described as being performed by a system of one or more processors (e.g., the user device 120, back-end system 100, a combination thereof, such as executing assistant application 122).

At block 402, the system presents a chat window associated with an assistant application. As described in FIG. 3A, the chat window may reflect a chat between a user of the system and a large language model (LLM).

At block 404, the system obtains information specifying a goal associated with a tutorial. The user may indicate a particular tutorial of interest. For example, the user may specify that they want a tutorial generated which uses one or more specific applications to perform a specific goal. The user may additionally cause the system to generate potential tutorial concepts for presentation via the chat window.

At block 406, the system forms a first prompt to the LLM based on a specified goal and associated documentation. As described in FIGS. 3B-3C, the LLM determine a step-by-step tutorial associated with the specified goal. The LLM may additionally determine validation information reflecting information sufficient to ascertain whether an end-user has completed each step.

At block 408, the system validates code from the LLM. As described in FIG. 3D, the system may validate code from the LLM reflecting the tutorial. While code is used herein, in some embodiments the LLM may generate structured information which forms a tutorial for end-user utilization. At block 410, the code may be iteratively updated until it is validated to be correct or otherwise workable.

In some embodiments, the tutorial may be updated based on a change in documentation, or functionality, associated with one of the applications used in the tutorial. For example, the system may monitor the documentation and determine when it has updated. The system may also monitor end-user use of the application and determine whether it is exhibiting new behavior. The system may also determine when a new version of the application is released.

Thus, the system may update the tutorial. In some embodiments, the system may use the LLM to generate a new tutorial (e.g., without reference to the pre-existing tutorial). The system may then provide both the pre-existing tutorial and new tutorial to a different LLM or different context window of the LLM. The system may provide relevant documentation associated with the application and ask the different LLM or context window if the new tutorial is better. The system can also ask the different LLM or context window to improve upon the new tutorial.

In some embodiments, the LLM may be provided the pre-existing tutorial and a difference or newly added matter to the documentation associated with the application. The LLM may then be asked to update the tutorial based on the difference or newly added matter.

### Tutorial Usage

FIG. 5A is a block diagram illustrating detail of the example user device 120 monitoring progression through an example tutorial. As described in FIGS. 3A-4, a context-aware tutorial may be generated which enables end-users to learn applications or specific flows through applications. In the illustrated example, the user device includes an assistant application 122 that may output a chat window for conversation between an end-user and a large language model (LLM) 110.

The assistant application 122 is in communication with one or more web application(s) 124 executing on the user device 120. For example, the web application(s) 124 may represent client-side applications such that the user device 120 presents user interfaces or front-ends associated with the application(s) 124. As described above, a communication channel 502 may be established between the web application(s) 124 and assistant application 122. For example, the communication channel 502 may represent a broadcast channel.

The communication channel 502 may pass message(s) or information which are reflective of an application state 504. For example, the application state 504 may be generated by a web application being utilized by the end-user as part of the tutorial. The application sate 504 may include, for example, an application identifier, user actions taken in the web application, and/or application information (e.g., the raw information described above). Optionally, the assistant application 122 may receive images or video reflecting end-user interaction with the web application. The images or video may be obtained via the assistant application 122 (e.g., it may obtain screenshots), the web application, or another application executing on the user device 120.

As described herein, the application state 504 may be used to determine whether the end-user has completed a step of the tutorial. Thus, the assistant application 122 can essentially have a hook into the web application itself. In some embodiments, the assistant application 122 will determine whether to accept an incoming message from one of the web applications based on a particular step the end-user is performing. For example, the assistant application 122 may determine, or otherwise receive information reflecting, that the end-user has completed two of four steps (e.g., the end-user is on step 3). In this example, step 3 may utilize a particular web application. Thus, the assistant application 122 may accept a message from the particular web application while discarding messages from other web applications. For example, the other web applications may have client applications in different browser tabs of a web browser.

To determine completion of a step, the assistant application 122 may optionally include a tutorial execution engine 508. The engine 508 may analyze a received application state and compare it to code forming, or a definition of, the tutorial. For example, as described herein the tutorial may specify validation information sufficient to determine completion of individual steps. The validation information may optionally indicate a particular application state, or application states, that trigger completion of a step. Thus, the tutorial execution engine 508 may listen for application states 504, and determine whether individual steps are completed. In this way, the application states 504 are maintained client-side and passed between client-side web applications.

FIG. 5B is a block diagram illustrating detail of the back-end system 100 and LLM 110 monitoring progression through the example tutorial. In some embodiments, the back-end system 100 may determine whether a step has been completed based on received application state 504. For example, the user device may provide the application states to the back-end system for analysis 100. The system 100 may compare the states to received tutorial information reflecting code associated with, or information forming a definition of, the tutorial.

In some embodiments, the LLM 110 may ascertain whether a step has been completed. For example, the LLM 110 may receive a prompt indicative of the chat window, the application state 504, and the tutorial information 506. The LLM 110 may then output whether an individual step has been completed.

FIG. 5C is a block diagram illustrating detail of the assistant application 122 receiving a user prompt, such as a question, related to the example tutorial. In the illustrated example, the assistant application 122 has determined that step B was not validated due to a particular error message. As described above, in some embodiments the error messages may be standardized such that similar errors result in same error messages. In some embodiments, a step may be analyzed for completion based on interaction with the chat window. For example, the end-user may select an option associated with completion of a step or may type a response noting the completion. Based on a failed validation, the LLM 110 may output an error message as illustrated.

The end-user has thus responded with a question as to how the end-user can perform step B. Prompt 530 may be formed, for example by the assistant application 122 (e.g., the back-end application on back-end system 100) which includes one or more of the chat history, current application state, prior application states, tutorial information, and so on. The LLM 110 may respond to the prompt 530, for example by including specific actions the end-user is to take to complete the step.

Advantageously, the prompt 530 includes the application states received from the relevant web application. Thus, the LLM 110 can understand the actions the end-user has already taken. The LLM 110 can additionally understand where in the web application the end-user currently is. For example, the LLM 110 can respond noting that the end-user should navigate to a particular selectable option and then proceed from there.

In some embodiments, user interface elements included in the web applications may be registered with the assistant application 122. For example, the user interface elements may have metadata indicating they may be suggested as widgets when an end-user is in a tutorial. Thus, the LLM 110 can identify the specific user interface element the end-user is to select. Additionally, the assistant application 122 can then cause the specific user interface element to be highlighted. For example, the application 122 may cause a layer to be presented over the user interface associated with the web application. The layer may highlight the specific user interface element while optionally masking or limiting visibility of other areas. In some embodiments, the assistant application 122 may provide a message to the web application (e.g., over communication channel 502) that indicates the web application should highlight the specific user interface element.

FIG. 5D is an example user interface 540 highlighting an interactive element 542 in an application associated with a tutorial based on the user prompt.

FIG. 6 is a flowchart of an example process for monitoring progression through an example tutorial. For convenience, the process 600 will be described as being performed by a system of one or more processors (e.g., the user device 120, back-end system 100, a combination thereof, such as executing assistant application 122).

At block 602, the system presents a chat window associated with an assistant application. As described above, for example with respect to at least FIG. 1A, an end-user can communicate with a large language model (LLM) via the chat window. The end-user can select a particular tutorial to follow based on the chat window. For example, the end-user can describe a particular tutorial of interest or describe frustrations with a particular application. The assistant application may then recommend or otherwise select a tutorial. The tutorial may then be obtained, such as code or information defining the tutorial. The system may enable the end-user to traverse through steps of the tutorial and validate when each step is completed.

At block 604, the system establishes a communication channel between the assistant application and web application(s). The end-user may cause a web application to be instantiated or executed, such that the end-user can view a user interface or front-end associated with the web application. The communication channel may then be established, for example using a broadcast channel as described herein.

At block 606, the system monitors progression through the tutorial using the LLM. The tutorial may indicate validation information sufficient to determine whether the end-user has completed a step. As described above, the web application may provide message(s) to the assistant application reflecting the web application’s state (referred to herein as the application state). The assistant application may thus determine whether a step is completed based on the application state. In some embodiments, the LLM may determine whether the step is completed.

The web application may optionally reflect a third-party application, for example one where the back-end is executed on an outside system. As described herein, the LLM may generate the tutorial based on third-party documentation which may be used based on explicit permission (e.g., not scraped). The third-party application may thus not output an application state. In some embodiments, the LLM may receive images or video of use of the third-party application. Based on the images or video the LLM can ascertain whether the end-user has completed a step. In some embodiments, a wrapper may be used to extract the application state. For example, the wrapper may generate images or video of use of the third-party application. In this example, the LLM, or a specialized ML model or LLM, may map the actions shown in the images or video to particular application states. These application states may then be routed to the assistant application. The wrapper may additionally obtain debug information generated by the third-party application. For example, the third-party application may enable a debug mode such that information reflecting use of the third-party application may be routed to the assistant application.

At block 608, the system responds to user questions regarding the tutorial. As described above, the LLM may respond to questions related to the steps of the tutorial. For example, the end-user may ask how they can create a repository associated with a particular type of programming language. In this example, the LLM may respond with explicit actions the end-user can take to create the repository.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the "C" programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

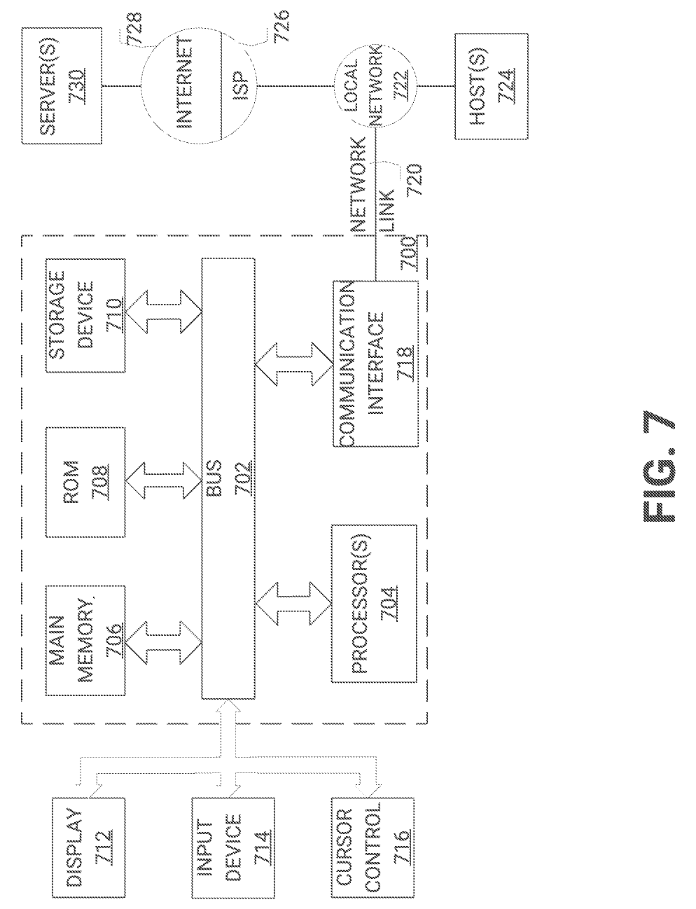

For example, FIG. 7 is a block diagram that illustrates a computer system 700 upon which various embodiments may be implemented. Computer system 700 includes a bus 702 or other communication mechanism for communicating information, and a hardware processor, or multiple processors, 704 coupled with bus 702 for processing information. Hardware processor(s) 704 may be, for example, one or more general purpose microprocessors.

Computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

Computer system 700 may be coupled via bus 702 to a display 712, such as a cathode ray tube (CRT) or LCD display (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 700 may include a user interface module to implement a GUI that may be stored in a mass storage device as computer executable program instructions that are executed by the computing device(s). Computer system 700 may further, as described below, implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more computer readable program instructions contained in main memory 706. Such instructions may be read into main memory 706 from another storage medium, such as storage device 710. Execution of the sequences of instructions contained in main memory 706 causes processor(s) 704 to perform the process steps described herein. In alternative embodiments, hard-wired circuitry may be used in place of or in combination with software instructions.

Various forms of computer readable storage media may be involved in carrying one or more sequences of one or more computer readable program instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN (or WAN component to communicated with a WAN). Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user’s computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

### Example Clauses

Examples of the implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A method implemented by one or more processors executing program instructions, the method comprising: causing presentation, via a first web application executing in a browser, of a chat window, the first web application being in communication with a large language model (LLM); obtaining information specifying a goal associated with a workflow through one or more second web applications configured for execution in the browser, the goal being associated with a tutorial generated, in part, using the LLM; forming a first prompt based on the specified goal and associated documentation, wherein the first web application provides the prompt to the LLM, and wherein the chat window is updated to present: information specifying steps towards the goal, wherein individual steps reference one or more second web applications; and validating information received from the LLM which is associated with the tutorial, wherein the information includes for an individual step: information identifying a particular web application associated with the step, and validation information indicative of a state associated with the particular web application that reflects successful completion of the step, wherein during use of the tutorial, the first web application is configured to receive, via a communication channel, information from the particular web application.

Clause 2. The method of clause 1, wherein the information received from the LLM is code, and wherein the first prompt includes a format for the LLM to follow when generating the code.

Clause 3. The method of clause 2, wherein the code is executed or interpreted, and wherein the LLM iterates upon the code to address identified errors.

Clause 4. The method of clause 1, wherein the first prompt includes a plurality of states the second applications can be in, and wherein the validation information specifies one or more of the states for each step.

Clause 5. The method of clause 1, wherein the associated document is determined using semantic search or retrieval-augmented generation, and wherein the associated documentation includes manuals, documents, or web resources associated with the second web applications.

Clause 6. The method of clause 1, wherein the information included for an individual step includes one or more example questions which are configured to be presented in the chat window during end-user use of the tutorial.

Clause 7. The method of clause 1, wherein the tutorial is configured to identify one or more user interface elements included in a particular second web application, and wherein during use of the tutorial the first web application is configured to cause identification of the one or more user interface elements as being associated with completion of a particular step.

Clause 8. A system comprising one or more processors and non-transitory computer storage media storing instructions that when executed by the one or more processors, cause the one or more processors to perform operations comprising: causing presentation, via a first web application executing in a browser, of a chat window, the first web application being in communication with a large language model (LLM); obtaining information specifying a goal associated with a workflow through one or more second web applications configured for execution in the browser, the goal being associated with a tutorial generated, in part, using the LLM; forming a first prompt based on the specified goal and associated documentation, wherein the first web application provides the prompt to the LLM, and wherein the chat window is updated to present: information specifying steps towards the goal, wherein individual steps reference one or more second web applications; and validating information received from the LLM which is associated with the tutorial, wherein the information includes for an individual step: information identifying a particular web application associated with the step, and validation information indicative of a state associated with the particular web application that reflects successful completion of the step, wherein during use of the tutorial, the first web application is configured to receive, via a communication channel, information from the particular web application.

Clause 9. The system of clause 8, wherein the information received from the LLM is code, and wherein the first prompt includes a format for the LLM to follow when generating the code.

Clause 10. The system of clause 9, wherein the code is executed or interpreted, and wherein the LLM iterates upon the code to address identified errors.

Clause 11. The system of clause 8, wherein the first prompt includes a plurality of states the second applications can be in, and wherein the validation information specifies one or more of the states for each step.

Clause 12. The system of clause 8, wherein the associated document is determined using semantic search or retrieval-augmented generation, and wherein the associated documentation includes manuals, documents, or web resources associated with the second web applications.

Clause 13. The system of clause 8, wherein the information included for an individual step includes one or more example questions which are configured to be presented in the chat window during end-user use of the tutorial.

Clause 14. The system of clause 8, wherein the tutorial is configured to identify one or more user interface elements included in a particular second web application, and wherein during use of the tutorial the first web application is configured to cause identification of the one or more user interface elements as being associated with completion of a particular step.

Clause 15. Non-transitory computer storage media storing instructions that when executed by a system of one or more computers, cause the one or more computers to perform operations comprising: causing presentation, via a first web application executing in a browser, of a chat window, the first web application being in communication with a large language model (LLM); obtaining information specifying a goal associated with a workflow through one or more second web applications configured for execution in the browser, the goal being associated with a tutorial generated, in part, using the LLM; forming a first prompt based on the specified goal and associated documentation, wherein the first web application provides the prompt to the LLM, and wherein the chat window is updated to present: information specifying steps towards the goal, wherein individual steps reference one or more second web applications; and validating information received from the LLM which is associated with the tutorial, wherein the information includes for an individual step: information identifying a particular web application associated with the step, and validation information indicative of a state associated with the particular web application that reflects successful completion of the step, wherein during use of the tutorial, the first web application is configured to receive, via a communication channel, information from the particular web application.

Clause 16. The computer storage media of clause 15, wherein the information received from the LLM is code, and wherein the first prompt includes a format for the LLM to follow when generating the code.

Clause 17. The computer storage media of clause 16, wherein the code is executed or interpreted, and wherein the LLM iterates upon the code to address identified errors.

Clause 18. The computer storage media of clause 15, wherein the first prompt includes a plurality of states the second applications can be in, and wherein the validation information specifies one or more of the states for each step.

Clause 19. The computer storage media of clause 15, wherein the associated document is determined using semantic search or retrieval-augmented generation, and wherein the associated documentation includes manuals, documents, or web resources associated with the second web applications.

Clause 20. The computer storage media of clause 15, wherein the tutorial is configured to identify one or more user interface elements included in a particular second web application, and wherein during use of the tutorial the first web application is configured to cause identification of the one or more user interface elements as being associated with completion of a particular step.

Clause 21. A method implemented by one or more processors executing program instructions, the method comprising: causing presentation, via a first web application executing in a browser, of a chat window, the first web application being in communication with a large language model (LLM), and the chat window reflecting one or more steps included in a tutorial; establishing communications, via a communication channel, between the first web application and a particular web application of one or more second web applications configured for execution via the browser to complete the tutorial; and monitoring, based on the communication channel, progression through the tutorial, wherein the chat window is updated based on the monitored progression, wherein each step is associated with information that indicates: a respective web application of the second web applications which is associated with the step, and validation information indicative of a state associated with the respective web application that reflects successful completion of the step, wherein monitoring progression through the tutorial includes validating completion of the steps, and wherein validating completion of a first step that indicates the particular web application comprises: validating that the particular web application is being executed, and validating that a current state of the particular web application corresponds to the validation information indicated in the information for the first step.

Clause 22. The method of clause 21, wherein the chat window includes summary information associated with the steps according to an order, and wherein the first web application monitors completion of the steps based on states associated with the second web applications.

Clause 23. The method of clause 22, wherein the communication channel is a broadcast channel, and wherein the first web application disallows communications from second web applications that are not associated with a current step.

Clause 24. The method of clause 21, wherein validating that the current state of the particular web application corresponds to the validation information is based on use of the LLM, wherein the current state and the validation information are input into the LLM as a prompt.

Clause 25. The method of clause 21, wherein the particular web application is capable of being in a plurality of known states, wherein the validation information for the first step includes a state selected from the known states, and wherein the first web application determines whether the current state matches with the included state.

Clause 26. The method of clause 21, wherein the tutorial is configured to identify a specific user interface element associated with the particular web application that is part of the first step, and wherein the identification is overlaid over a user interface presented via the particular web application.

Clause 27. The method of clause 21, wherein the chat window is configured to receive user questions, and wherein the LLM is configured to respond to the user questions to guide the end-user towards completion of the tutorial.

Clause 28. A system comprising one or more processors and non-transitory computer storage media storing instructions that when executed by the one or more processors, cause the one or more processors to perform operations comprising: causing presentation, via a first web application executing in a browser, of a chat window, the first web application being in communication with a large language model (LLM), and the chat window reflecting one or more steps included in a tutorial; establishing communications, via a communication channel, between the first web application and a particular web application of one or more second web applications configured for execution via the browser to complete the tutorial; and monitoring, based on the communication channel, progression through the tutorial, wherein the chat window is updated based on the monitored progression, wherein each step is associated with information that indicates: a respective web application of the second web applications which is associated with the step, and validation information indicative of a state associated with the respective web application that reflects successful completion of the step, wherein monitoring progression through the tutorial includes validating completion of the steps, and wherein validating completion of a first step that indicates the particular web application comprises: validating that the particular web application is being executed, and validating that a current state of the particular web application corresponds to the validation information indicated in the information for the first step.

Clause 29. The system of clause 28, wherein the chat window includes summary information associated with the steps according to an order, and wherein the first web application monitors completion of the steps based on states associated with the second web applications.

Clause 30. The system of clause 29, wherein the communication channel is a broadcast channel, and wherein the first web application disallows communications from second web applications that are not associated with a current step.

Clause 31. The system of clause 28, wherein validating that the current state of the particular web application corresponds to the validation information is based on use of the LLM, wherein the current state and the validation information are input into the LLM as a prompt.

Clause 32. The system of clause 28, wherein the particular web application is capable of being in a plurality of known states, wherein the validation information for the first step includes a state selected from the known states, and wherein the first web application determines whether the current state matches with the included state.

Clause 33. The system of clause 28, wherein the tutorial is configured to identify a specific user interface element associated with the particular web application that is part of the first step, and wherein the identification is overlaid over a user interface presented via the particular web application.

Clause 34. The system of clause 28, wherein the chat window is configured to receive user questions, and wherein the LLM is configured to respond to the user questions to guide the end-user towards completion of the tutorial.

Clause 35. Non-transitory computer storage media storing instructions that when executed by a system of one or more computers, cause the one or more computers to perform operations comprising: causing presentation, via a first web application executing in a browser, of a chat window, the first web application being in communication with a large language model (LLM), and the chat window reflecting one or more steps included in a tutorial; establishing communications, via a communication channel, between the first web application and a particular web application of one or more second web applications configured for execution via the browser to complete the tutorial; and monitoring, based on the communication channel, progression through the tutorial, wherein the chat window is updated based on the monitored progression, wherein each step is associated with information that indicates: a respective web application of the second web applications which is associated with the step, and validation information indicative of a state associated with the respective web application that reflects successful completion of the step, wherein monitoring progression through the tutorial includes validating completion of the steps, and wherein validating completion of a first step that indicates the particular web application comprises: validating that the particular web application is being executed, and validating that a current state of the particular web application corresponds to the validation information indicated in the information for the first step.

Clause 36. The computer storage media of clause 35, wherein the chat window includes summary information associated with the steps according to an order, and wherein the first web application monitors completion of the steps based on states associated with the second web applications.

Clause 37. The computer storage media of clause 36, wherein the communication channel is a broadcast channel, and wherein the first web application disallows communications from second web applications that are not associated with a current step.

Clause 38. The computer storage media of clause 35, wherein validating that the current state of the particular web application corresponds to the validation information is based on use of the LLM, wherein the current state and the validation information are input into the LLM as a prompt.

Clause 39. The computer storage media of clause 35, wherein the particular web application is capable of being in a plurality of known states, wherein the validation information for the first step includes a state selected from the known states, and wherein the first web application determines whether the current state matches with the included state.

Clause 40. The computer storage media of clause 35, wherein the tutorial is configured to identify a specific user interface element associated with the particular web application that is part of the first step, and wherein the identification is overlaid over a user interface presented via the particular web application.

What is claimed is:

1. A method implemented by one or more processors executing program instructions, the method comprising:
causing presentation, via a first web application executing in a browser, of a chat window, the first web application being in communication with a large language model (LLM), and the chat window reflecting one or more steps included in a tutorial;
establishing communications, via a communication channel, between the first web application and a particular web application of one or more second web applications configured for execution via the browser to complete the tutorial; and
monitoring, based on the communication channel, progression through the tutorial, wherein the chat window is updated based on the monitored progression,
wherein each step is associated with information that indicates:
a respective web application of the second web applications which is associated with the step, and
validation information indicative of a state associated with the respective web application that reflects successful completion of the step,
wherein monitoring progression through the tutorial includes validating completion of the steps, and wherein validating completion of a first step that indicates the particular web application comprises:
validating that the particular web application is being executed, and
validating that a current state of the particular web application corresponds to the validation information indicated in the information for the first step.

2. The method of claim 1, wherein the chat window includes summary information associated with the steps according to an order, and wherein the first web application monitors completion of the steps based on states associated with the second web applications.

3. The method of claim 2, wherein the communication channel is a broadcast channel, and wherein the first web application disallows communications from second web applications that are not associated with a current step.

4. The method of claim 1, wherein validating that the current state of the particular web application corresponds to the validation information is based on use of the LLM, wherein the current state and the validation information are input into the LLM as a prompt.

5. The method of claim 1, wherein the particular web application is capable of being in a plurality of known states, wherein the validation information for the first step includes a state selected from the known states, and wherein the first web application determines whether the current state matches with the included state.

6. The method of claim 1, wherein the tutorial is configured to identify a specific user interface element associated with the particular web application that is part of the first step, and wherein the identification is overlaid over a user interface presented via the particular web application.

7. The method of claim 1, wherein the chat window is configured to receive user questions, and wherein the LLM is configured to respond to the user questions to guide the end-user towards completion of the tutorial.

8. A system comprising one or more processors and non-transitory computer storage media storing instructions that when executed by the one or more processors, cause the one or more processors to perform operations comprising:
causing presentation, via a first web application executing in a browser, of a chat window, the first web application being in communication with a large language model (LLM), and the chat window reflecting one or more steps included in a tutorial;
establishing communications, via a communication channel, between the first web application and a particular web application of one or more second web applications configured for execution via the browser to complete the tutorial; and
monitoring, based on the communication channel, progression through the tutorial, wherein the chat window is updated based on the monitored progression,
wherein each step is associated with information that indicates:
a respective web application of the second web applications which is associated with the step, and
validation information indicative of a state associated with the respective web application that reflects successful completion of the step,
wherein monitoring progression through the tutorial includes validating completion of the steps, and wherein validating completion of a first step that indicates the particular web application comprises:
validating that the particular web application is being executed, and
validating that a current state of the particular web application corresponds to the validation information indicated in the information for the first step.

9. The system of claim 8, wherein the chat window includes summary information associated with the steps according to an order, and wherein the first web application monitors completion of the steps based on states associated with the second web applications.

10. The system of claim 9, wherein the communication channel is a broadcast channel, and wherein the first web application disallows communications from second web applications that are not associated with a current step.

11. The system of claim 8, wherein validating that the current state of the particular web application corresponds to the validation information is based on use of the LLM, wherein the current state and the validation information are input into the LLM as a prompt.

12. The system of claim 8, wherein the particular web application is capable of being in a plurality of known states, wherein the validation information for the first step includes a state selected from the known states, and wherein the first web application determines whether the current state matches with the included state.

13. The system of claim 8, wherein the tutorial is configured to identify a specific user interface element associated with the particular web application that is part of the first step, and wherein the identification is overlaid over a user interface presented via the particular web application.

14. The system of claim 8, wherein the chat window is configured to receive user questions, and wherein the LLM is configured to respond to the user questions to guide the end-user towards completion of the tutorial.

15. Non-transitory computer storage media storing instructions that when executed by a system of one or more computers, cause the one or more computers to perform operations comprising:
causing presentation, via a first web application executing in a browser, of a chat window, the first web application being in communication with a large language model (LLM), and the chat window reflecting one or more steps included in a tutorial;
establishing communications, via a communication channel, between the first web application and a particular web application of one or more second web applications configured for execution via the browser to complete the tutorial; and
monitoring, based on the communication channel, progression through the tutorial, wherein the chat window is updated based on the monitored progression,
wherein each step is associated with information that indicates:
a respective web application of the second web applications which is associated with the step, and
validation information indicative of a state associated with the respective web application that reflects successful completion of the step,
wherein monitoring progression through the tutorial includes validating completion of the steps, and wherein validating completion of a first step that indicates the particular web application comprises:
validating that the particular web application is being executed, and
validating that a current state of the particular web application corresponds to the validation information indicated in the information for the first step.

16. The computer storage media of claim 15, wherein the chat window includes summary information associated with the steps according to an order, and wherein the first web application monitors completion of the steps based on states associated with the second web applications.

17. The computer storage media of claim 16, wherein the communication channel is a broadcast channel, and wherein the first web application disallows communications from second web applications that are not associated with a current step.

18. The computer storage media of claim 15, wherein validating that the current state of the particular web application corresponds to the validation information is based on use of the LLM, wherein the current state and the validation information are input into the LLM as a prompt.

19. The computer storage media of claim 15, wherein the particular web application is capable of being in a plurality of known states, wherein the validation information for the first step includes a state selected from the known states, and wherein the first web application determines whether the current state matches with the included state.

20. The computer storage media of claim 15, wherein the tutorial is configured to identify a specific user interface element associated with the particular web application that is part of the first step, and wherein the identification is overlaid over a user interface presented via the particular web application.
